(19) United States
(12) Patent Application Publication
(10) Pub. No.: US 2002/0096123 A1
(43) Pub. Date: Jul. 25, 2002

(54) Integrated herd management system utilizing isolated populations of X-chromosome bearing and Y-chromosome bearing spermatozoa

(75) Inventors: Jack C. Whittier, Wellington, CO (US); Barbi A. Riggs, Outlook, MT (US); Patrick D. Burns, Fort Collins, CO (US); George Seidel, LaPorte, CO (US)

Correspondence Address: Santangelo Law Offices, P.C., Third Floor, 125 South Howes, Fort Collins, CO, 80521, US

(73) Assignee: Colorado State University, Colorado State University Research Foundation, Fort Collins, CO (US)

(21) Appl. No.: 09/879,480

(22) Filed: Jun. 12, 2001

Related U.S. Application Data
(63) Continuation-in-part of application No. 09/511,959, filed on Feb. 23, 2000.
Application No. 09/511,959 is a division of application No. 09/001,394, filed on Dec. 31, 1997.
(63) Continuation-in-part of application No. 09/582,809, filed on Jun. 30, 2000.
Application No. 09/582,809 is a 371 of international application No. PCT/US98/27909, filed on Dec. 31, 1998.
Application No. PCT/US98/27909 is a continuation-in-part of application No. 09/001,394, filed on Dec. 31, 1997.
Application No. PCT/US98/27909 is a continuation-in-part of application No. 09/015,454, filed on Jan. 29, 1998.
(63) Continuation-in-part of application No. 09/448,643, filed on Nov. 24, 1999.
Application No. 09/448,643 is a continuation of application No. 09/015,454, filed on Jan. 29, 1998.
(63) Continuation-in-part of application No. 09/744,675, filed on Jan. 29, 2001.
(60) Provisional application No. 60/113,143, filed on Dec. 18, 1998.
(60) Provisional application No. 60/094,720, filed on Jul. 30, 1998.
(60) Provisional application No. 60/224,050, filed on Aug. 9, 2000.
(60) Provisional application No. 60/211,093, filed on Jun. 12, 2000.

(51) Int. Cl. A01K 29/00

(52) U.S. Cl. 119/174

(57) ABSTRACT

Animal management systems that utilizes artificial insemination (27) samples of isolated X-chromosome bearing and Y-chromosome bearing populations of spermatozoa to inseminate female animals (17) an embodiment of which can provide an alternative to traditional harvesting or marketing (20) of non-replacement heifers.

### I. TECHNICAL FIELD

Generally, herd management technologies utilizing isolated populations of X-chromosome bearing spermatozoa and Y-chromosome bearing spermatozoa that may be used with a variety of species of mammals. Specifically, an integrated bovine herd management system that utilizes isolated populations of X-chromosome bearing spermatozoa in a single-calf heifer system to increase the value of non-replacement heifers.

### II. BACKGROUND

Economic pressures to improve beef cattle production efficiency have prompted the industry and researchers to evaluate various production systems. One conventional herd management system that has received considerable attention is the single-calf heifer system (SCH). This system has the capability to utilize non-replacement females normally targeted for slaughter. Simulated SCH systems compared to other beef management schemes using average costs of production and returns for products from 1958 to 1986 can be shown to be profitable. However, in order for a SCH system to remain economically sustainable, the end product must be acceptable to the consumer. The most essential component of the SCH system is that the heifer calve and be ready for harvest before she is 30 mo of age in order to avoid advanced carcass maturity.

Carcasses of advanced maturity pose problems in palatability, and therefore may be penalized by financial discounts. The USDA has set the approximate chronological age that corresponds to the physiological maturity score of “B” or greater to be 30 months of age or greater. However, maturity scores may increase with increasing chronological age at a much faster rate than USDA indicates and therefore suggested that animals 24 months of age and greater more accurately correspond to USDA maturity scores of “B” or greater. Therefore, to minimize risk of financial discounts and provide the consumer with a highly palatable product, target age of harvest for a SCH may be less than 24 months of age.

The SCH system can be designed to produce a carcass from the SCH as well as a calf. The carcass of the SCH must be of high quality but must not sacrifice the quality of the progeny. A production system in which a SCH is to rear a calf and be ready for harvest by 24 months of age, can possibly be accomplished by breeding the heifer at a non-traditional age of 9 months. Furthermore, it has been hypothesized that the younger the cow herd, the greater proportion of total feed used for weight production and a smaller amount of feed used for maintenance, lactation, gestation, and body condition score, hence increased biological efficiency.

It has also been hypothesized that if a SCH could produce only female calves, then only one parturition per female may be necessary and the dam could be slaughtered at a young enough age to still attain consumer acceptability without maturity discounts, thus creating a self-perpetuating herd system. Mating young cows to sexed-semen to yield female progeny may also reduce calving difficulties and increase calf survival.

To accomplish early breeding, induction of early puberty is necessary. Maturation into this state involves complex interactions between endocrine function, environment, social environment, breed, nutrition, and weight to bring about the development of reproductive tract and reproductive function. Diet is an effective tool to induce puberty. High-energy diets have been reported to induce onset of puberty in heifers at earlier ages than diets of lower energy. Weight of heifers tends to have a greater impact on puberty than age at puberty. Furthermore, heifers fed diets high in propionate production in the rumen reached puberty at lighter weights. Similarly, it has been found that diets containing ionophores decreased the age at onset of puberty, not related to ADG or body weight. Although plane of nutrition is inversely related to age at puberty, pattern of gain has no effect on age at puberty as long as heifers reach approximately 60-65% of mature body weight prior to breeding season. Hence, induction of early puberty depends on reaching target weights at a young age by feeding a feedlot-type diet high in energy and along with an ionophore. Early-weaning non-replacement heifers and managing them in feedlot conditions immediately following weaning is a means of reaching target weights as early in life as possible.

Early weaning has proven to be a tool to increase dams BCS without detrimental effects on calves. It has been found that early-weaned heifers placed on high quality diets resulted in faster rates of gain than contemporaries that remained on their dams. Furthermore, early-weaned calves may be more efficient in feed conversion; in addition they had greater total gains from birth until slaughter.

Even though there have been a variety of innovations, as described in the foregoing, with respect to herd management technologies, conventional herd management systems including the SCH herd management system have significant problems that remain unresolved.

Averaged over thousands of animals, about half the number of births in a herd will be female and the half male. For example, in conventional beef cattle herds 49% of calves born will be heifers. Due to chance alone, however, it is not unusual to have only 40% heifers from 100 consecutive calvings.

As such, a significant problem with conventional herd management systems can be that at equilibrium about 40% of beef females must be breed for herd replacements to maintain herd size because over half the calves born are bulls, and some of the heifers born either die, become unthrifty, or do not become pregnant. With respect to the conventional SCH herd management systems, replacement females must be purchased to perpetuate the herd if females are harvested shortly after weaning of their calf.

Another significant problem with conventional herd management systems can be that females average a lower weight and command a lower price at the time of sale than males under identical management. For example, under identical management, at weaning steers can average 519 pounds and garner an average of $0.92 per pound, while heifers can average 491 pounds and garner an average of $0.85 per pound. In this case, the steers provide a $60.00 advantage at sale solely due to their sex.

With respect to the problems with conventional herd management systems and specifically with SCH herd management as above-described, the invention addresses each in a practical fashion.

### III. DISCLOSURE OF THE INVENTION

It is now possible to isolate populations of X-chromosome bearing or Y-chromosome bearing populations of spermatozoa. Certain technologies such as flow cytometry allow spermatozoa to be sorted with an accuracy of greater than 90%. Separated spermatozoa can be utilized to accomplish in vitro or in vivo artificial insemination of or fertilization of oocytes of numerous mammals such as bovids, equids, ovids, goats, swine, dogs, cats, camels, oxen, buffalo, or the like. See for example, WO 96/12171; WO 00/06193; WO 99/33956; and PCT/US01/15150, each hereby incorporated by reference.

Accordingly, a broad object of embodiments of this invention can be to provide herd management systems which utilize isolated populations of X-chromosome bearing or Y-chromosome bearing spermatozoa.

One aspect of this broad object of the invention can be to increase the percentage of female animals available to expand an existing herd or to sell as replacement heifers. A herd management program utilizing populations of X-chromosome bearing spermatozoa of greater than 90% purity would allow a large surplus of female animals.

Another aspect of this broad object of the invention can be to increase selection intensity by allowing insemination of fewer but superior dams to produce replacement heifers. For example, in a beef herd at equilibrium about 40% of beef females must be breed for herd replacements to maintain herd size. With isolated populations of X-chromosome bearing spermatozoa, only 20% of females would need to be bred for replacements instead of the normal 40%, thus increasing selection intensity.

Another aspect of this broad object of the invention can be to breed females to bear females to decrease the incidence of birthing difficulty. A major problem on ranches, for example, is dystocia when heifers calve. The majority of dystocias are due to bull calves that average about five pounds heavier than heifers. This can be minimized by using isolated X-chromosome bearing spermatozoa from sires that generate a low incidence of difficult births.

Another aspect of this broad object of the invention can be to dispense with the conventional cow herd all together. Utilizing isolated populations of X-chromosome bearing spermatozoa, it can be possible to have every female replace herself with a heifer calf just before being fattened for harvest.

Another aspect of this broad object of the invention can be to provide a terminal cross program that produces only males. In certain embodiments of this invention, cows could have substantially terminal cross bull calves by artificial insemination with isolated populations of Y-chromosome bearing spermatozoa of 90% or greater purity. In other embodiments of this invention, an all male terminal-cross system could be used by purchasing all replacement heifers.

Yet another aspect of this broad object of the invention can be to integrate early-weaning, induced puberty, or sexed semen into a single-calf heifer system to increase value of non-replacement heifers. The integrated system would produce high quality products available to the consumer as well as provide a producer an alternative management system that has the potential to increase profitability.

Naturally further objects of the invention are disclosed throughout other areas of the specification and claims.

### IV. BRIEF DESCRIPTION OF THE DRAWINGS

FIG. 1 shows a generalized flow cytometer system used to sort X-chromosome bearing spermatozoa from Y-chromosome bearing.

FIG. 2 shows a second view of a generalized flow cytometer generalized flow cytometer system used to sort X-chromosome bearing spermatozoa from Y-chromosome bearing.

FIG. 3 shows herd management system that uses traditional weaning methods.

FIG. 4 shows a herd management system that uses early weaning methods.

FIG. 5 shows an embodiment of the herd management invention using isolated Y-chromosome enriched populations of spermatozoa.

FIG. 6 shows an embodiment of the herd management invention using isolated Y-chromosome enriched populations of spermatozoa and early weaned offspring.

FIG. 7 shows an embodiment of the herd management invention using isolated X-chromosome enriched populations of spermatozoa.

FIG. 8 shows an embodiment of an estrus synchronization protocol.

### V. MODE(S) FOR CARRYING OUT THE INVENTION

The invention involves herd management technology utilizing isolated X-chromosome bearing and Y-chromosome bearing populations of spermatozoa or sperm cells. X-chromosome bearing and Y-chromosome bearing populations of spermatozoa can comprise populations of intact live spermatozoa, or may also comprise frozen populations of X-chromosome bearing and Y-chromosome bearing spermatozoa. While particular examples of the invention are provided in the context of herds comprising beef cattle, it should be understood that the technologies described can have various applications with respect to a variety of species of mammal including, but not limited to, humans, bovids, equids, ovids, canids, felids, goats, or swine, as well as less commonly known animals such as elephants, zebra, camels, or kudu. This list of animals is intended to be exemplary of the great variety of animals from which spermatozoa can obtained and routinely isolated into X-chromosome and Y-chromosome bearing populations and to which this herd management invention can apply. As such, the examples provided are not intended to limit the description of the invention to the management of any particular specie(s) of mammal(s).

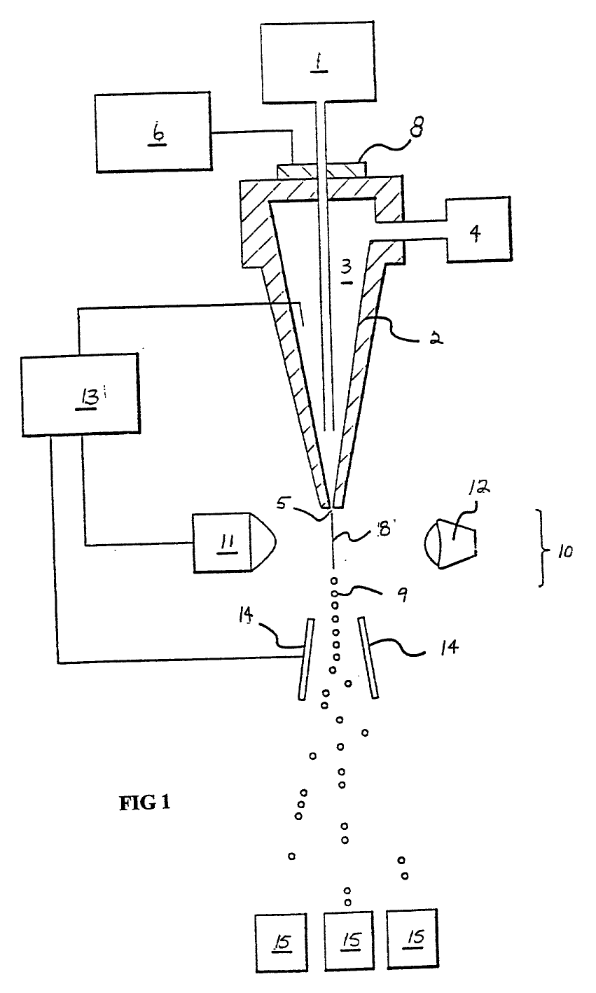

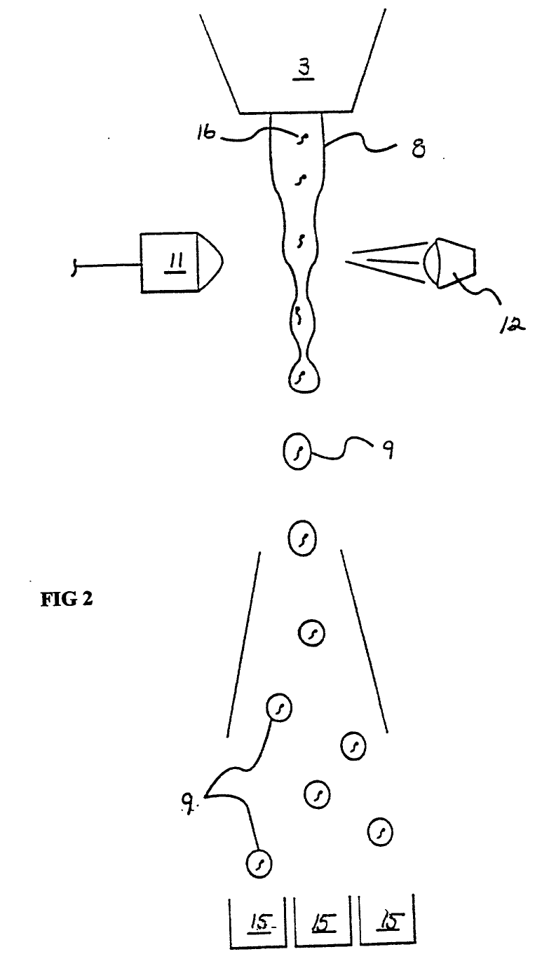

Now referring to FIGS. 1 and 2, an embodiment of the herd management system invention uses X-chromosome bearing and Y-chromosome bearing spermatozoa isolated by a flow cytometer. Flow cytometers used to isolate populations of X-chromosome bearing or Y-chromosome bearing spermatozoa can comprise a sperm cell source (1) which acts to establish or supply spermatozoa stained with at least one fluorochrome for analysis. The stained spermatozoa are deposited within a nozzle (2) in a manner such that the stained spermatozoa are introduced into a fluid stream or sheath fluid (3). The sheath fluid (3) is usually supplied by some sheath fluid source (4) so that as the sperm cell source (1) supplies the stained spermatozoa into the sheath fluid (4) they are concurrently fed through the nozzle (2).

In this manner it can be easily understood how the sheath fluid (3) forms a sheath fluid environment for the sperm cells. Since the various fluids are provided to the flow cytometer at some pressure, they flow out of nozzle (2) and exit at the nozzle orifice (5). By providing some type of oscillator (6) which may be very precisely controlled through an oscillator control (7), pressure waves may be established within the nozzle (2) and transmitted to the fluids exiting the nozzle (2) at nozzle orifice (5). Since the oscillator (6) acts upon the sheath fluid (3), the stream (8) exiting the nozzle orifice (5) eventually and regularly forms drops (9). Because the sperm cells are surrounded by the fluid stream or sheath fluid environment, the drops (9) may entrain within them individually isolated sperm cells.

Since the drops (9) can entrain sperm cells, the flow cytometer can be used to separate sperm cells based upon sperm cell characteristics. This is accomplished through a sperm cell sensing system (10). The sperm cell sensing system involves at least some type of detector or sensor (11) that responds to the sperm cells contained within fluid stream (8). The particle or cell sensing system (10) may cause an action depending upon the relative presence or relative absence of a characteristic, such as fluorochrome bound to the sperm cell or the DNA within the sperm cell that may be excited by an irradiation source such as a laser exciter (12) generating an irradiation beam to which the sperm cell can be responsive.

With respect to spermatozoa, the availability of binding sites for Hoechst 33342 stain is dependant upon the amount of DNA contained within each spermatozoon. Because X-chromosome bearing spermatozoa contain more DNA than Y-chromosome bearing spermatozoa, the X-chromosome bearing spermatozoa can bind a greater amount of fluorochrome than Y-chromosome bearing spermatozoa. Thus, by measuring the fluorescence emitted by the bound fluorochrome upon excitation, it is possible to differentiate between X-bearing spermatozoa and Y-bearing spermatozoa.

In order to achieve separation and isolation of spermatozoa based upon the amount of light emitted, emitted light can be received by a sensor (11) and fed to some type of separation discrimination system or analyzer (13) coupled to a droplet charger which differentially charges each droplet (9) based upon the amount of DNA within the sperm cell within that droplet (9). In this manner the separation discrimination system or analyzer (13) acts to permit the electrostatic deflection plates (14) to deflect drops (9) based on whether or not they contain an X-chromosome bearing spermatozoa or a Y-chromosome bearing spermatozoa.

As a result, the flow cytometer acts to separate the differentiated spermatozoa (16) by causing them to be directed to one or more collection containers (15). For example, when the analyzer differentiates sperm cells based upon a sperm cell characteristic, the droplets entraining X-chromosome bearing spermatozoa can be charged positively and thus deflect in one direction, while the droplets entraining Y-chromosome bearing spermatozoa can be charged negatively and thus deflect the other way, and the wasted stream (that is droplets that do not entrain a particle or cell or entrain undesired or unsortable cells) can be left uncharged and thus is collected in an undeflected stream into a suction tube or the like as discussed in U.S. patent application Ser. No. 09/001,394, hereby incorporated by reference herein. Naturally, numerous deflection trajectories can be established and collected simultaneously.

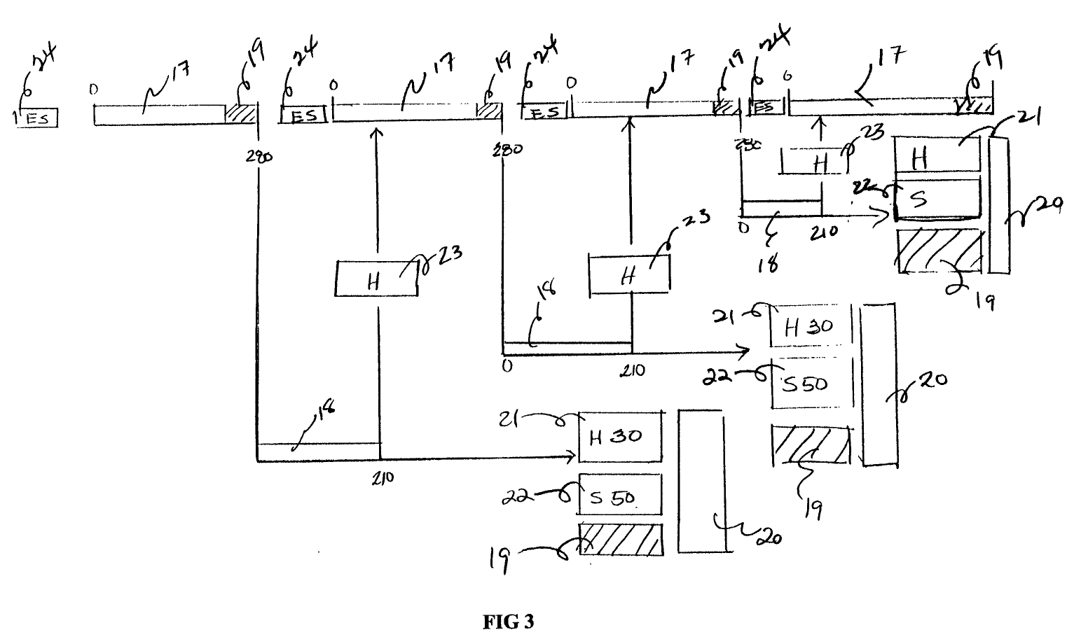

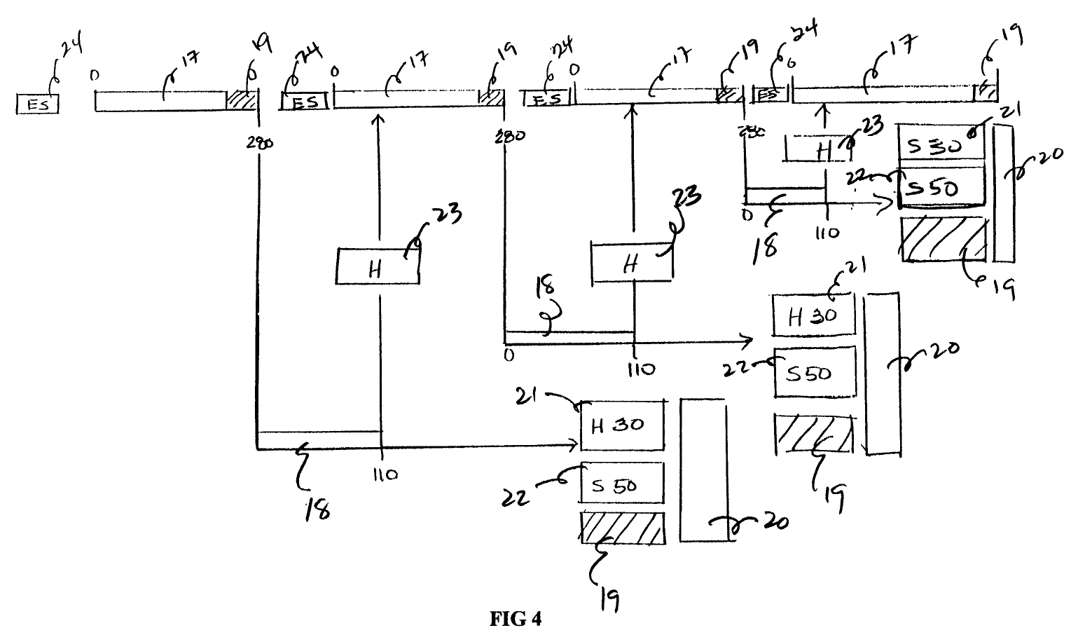

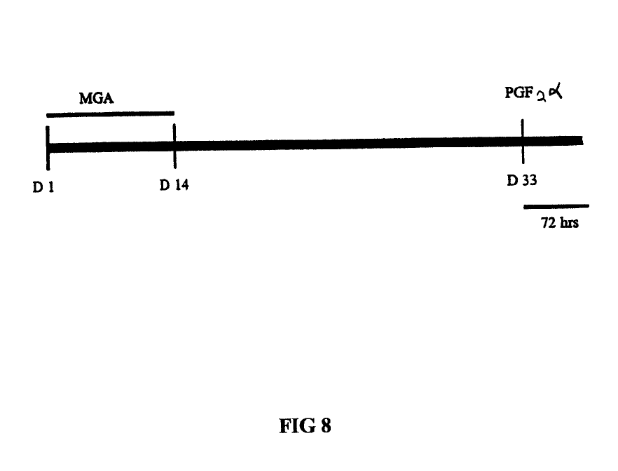

Now referring to FIGS. 3 and 4, conventional herd management comprises a herd of dams (17) of varying age and calves (18) that that over thousands of calves can typically comprise about 50% females and about 50% males. As can be understood from the figures, typically a portion of the herd of dams (19) is sold to the marketplace (20) along with a portion of the heifers (21) and substantially all the steers (22). A portion of the heifers (23) can provide replacements for the dams sold to the marketplace (20) although some replacement animals can also be bought outside of the herd to normalize the herd or improve herd genetics. For convenience and economic efficiency, all the dams can be brought into estrous at about the same time through a variety of estrous synchronization protocols (24). FIG. 8 shows one type of estrous synchronization protocol and that protocol is more fully described in Example 1 below.

In addition, as shown by FIG. 4, the calves can be early weaned at about 95 days to about 125 days as compared to traditional weaning at about 200 to about 230 days. Early weaning can be good tool to increase the BCS of dams, provide faster weight gain in calves, and can provide more efficient feed conversion.

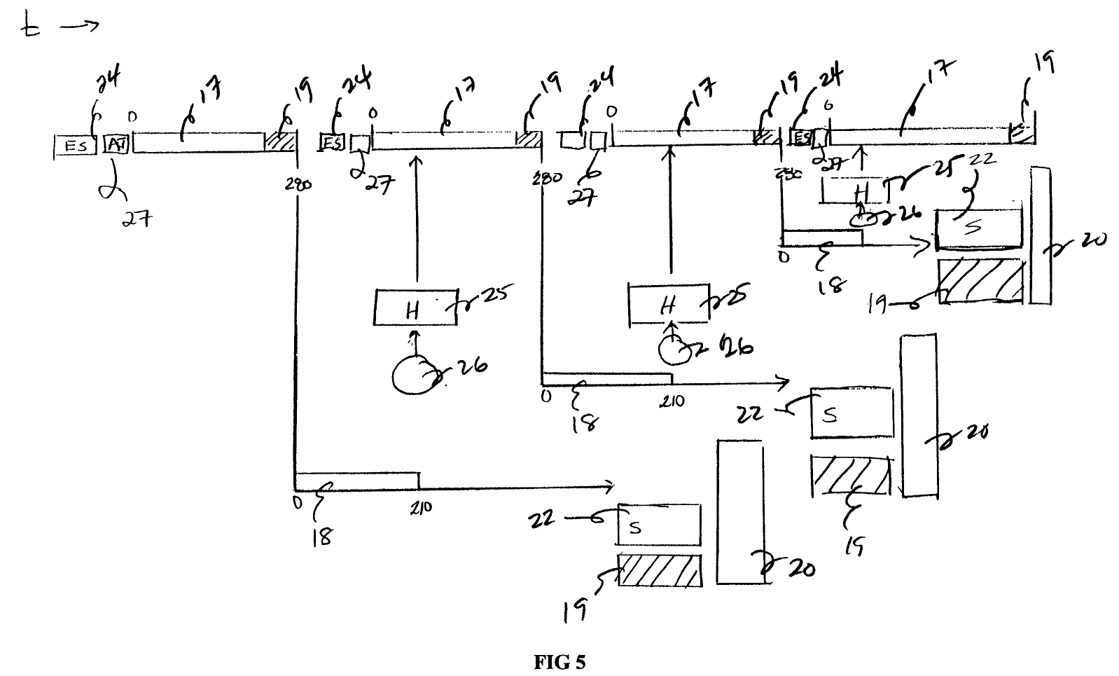

Now referring to FIG. 5, a generalized herd management invention is disclosed which can be used with a variety of species of animals as above-described. The herd management invention utilizes isolated populations of Y-chromosome bearing spermatozoa (some portion of the X-chromosome bearing spermatozoa population has been removed to enrich the ratio of Y-chromosome bearing spermatozoa to X-chromosome bearing spermatozoa in the total population) to provide a terminal cross that generates a desired ratio of male offspring mammals (18) to female offspring mammals. As can be understood from FIG. 5, in certain embodiments of the invention substantially all the offspring mammals can be male offspring Isolated populations of Y-chromosome bearing spermatozoa from numerous species of mammals can be produces as described above. Isolated populations of Y-chromosome bearing spermatozoa can be differentiated based upon this sex differentiation characteristic and at least 70%, at least 80%, at least 90%, or even higher percentages, even at least 98% of a plurality of spermatozoa can have a sex determination characteristic corresponding to the same sex of offspring mammal. These isolated populations of Y-chromosome bearing spermatozoa can be used in the context of various estrous synchronization protocols (24) and artificial insemination protocols (27) including, but not limited to, those estrous synchronization protocols and artificial insemination protocols described in U.S. patent application Ser. Nos. 09/001,394 and 09/015,454, each hereby incorporated by reference, to inseminate the dams (17) and fertilize at least one egg within the female of a species of mammal. The sex of the offspring mammals produced (18) can be predetermined based upon the ratio of Y-chromosome bearing spermatozoa to X-chromosome bearing spermatozoa in the artificial insemination samples used to inseminate the female of the species of mammal. Certain embodiments of the invention adjust the population of male offspring mammals to a percentage of male offspring mammals of at least 70%, at least 80%, at least 90%, or even greater. When isolated populations of X-chromosome bearing or Y-chromosome bearing spermatozoa are used in artificial insemination protocols (27), the number of non-frozen live spermatozoa can be selected such that the artificial insemination sample contains the desired number. In the context of inseminating bovine mammals, the number of isolated Y-chromosome bearing spermatozoa in the artificial insemination sample can be no more than 10 million, for example. A low number of spermatozoa from about 10% to about 50% relative to the typical number of spermatozoa in an artificial insemination sample may be used. In certain species of bovine mammals, such as beef cattle, the number of spermatozoa can be no more than 5 million, no more than 3 million, or can even be as low as no more than 500,000, no more than 250,000, and in some embodiments of the invention no more than between 100,000 to 150,000 spermatozoa. In certain embodiments of the invention, the spermatozoa can be frozen and subsequently thawed prior to use. The number of motile spermatozoa in a frozen-thawed sample of spermatozoa may be reduced.

Similarly, when the invention is used in the context of equine mammals, the artificial insemination sample can comprise live non-frozen spermatozoa having a number of no more than 25 million, no more than 15 million, no more than 10 million, or no more than 5 million. Similar numbers of spermatozoa may be frozen and subsequently thawed prior to use. Various protocols for the insemination of equine mammals are further disclosed by PCT/US99/17165, hereby incorporated by reference.

As described above, in the context of beef cattle, upon weaning male animals (22) sold to the marketplace (20) can generate more revenue than female animals under identical herd management. Where the sex of the offspring mammals produced is substantially male animals, replacement animals (25) may have to be obtained from an external source (26). In some embodiments of the invention, 20% of the dams (17) are replaced each year once the herd is normalized.

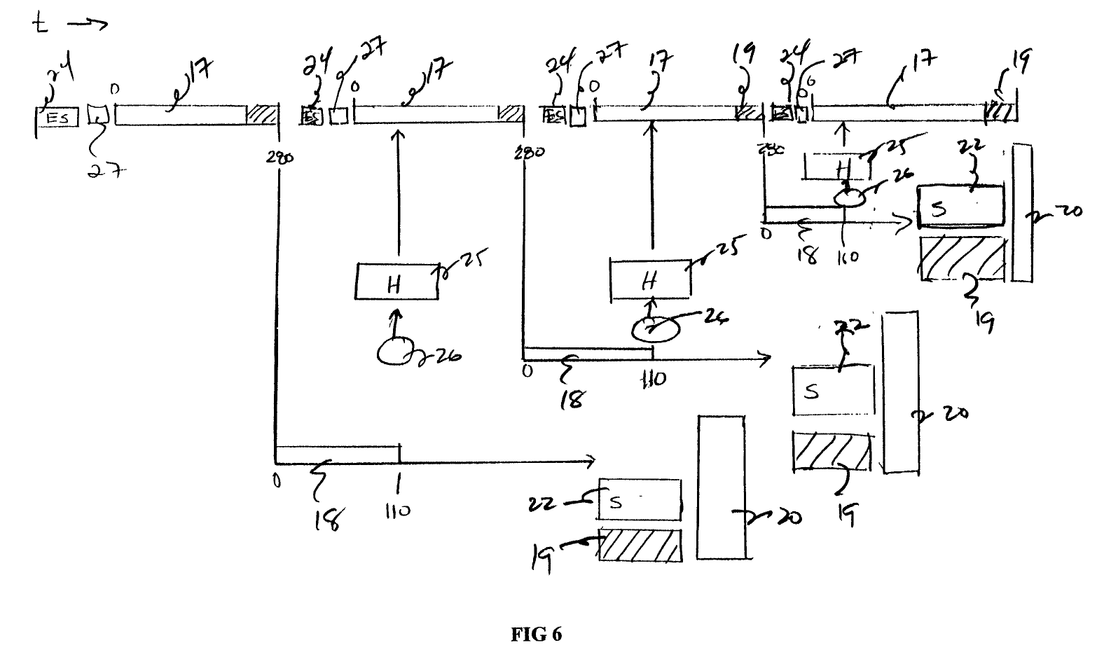

Now referring to FIG. 6, the invention can further comprise early weaning of male offspring (18) (or the desired sex ratio of offspring afforded by artificial insemination with populations of spermatozoa having known ratios of X-chromosome to Y-chromosome bearing spermatozoa). Understandable actual number of days to weaning of the offspring mammal can vary from species to species. Early weaning can be, with respect to beef cattle, as early as 95 days, or at an average age of about 110 days, or in certain embodiments of the invention between about 95 days to about 125 days. Additional embodiments of early weaned bovine mammal management are provided by Example 1 below.

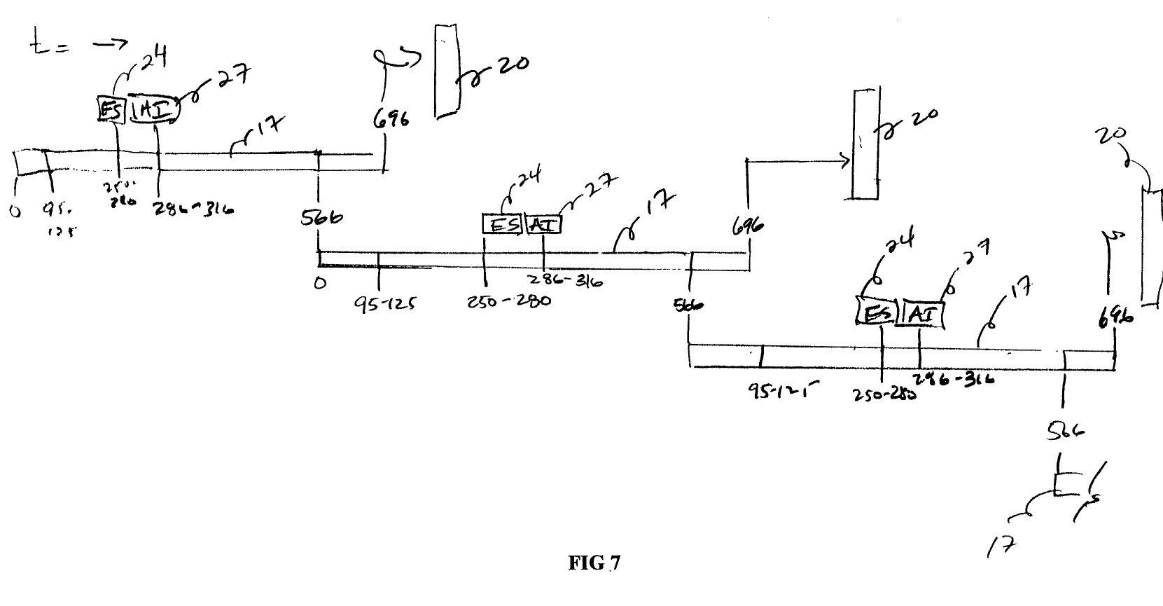

Now referring to FIG. 7, a generalized herd management invention is disclosed which can be used with a variety of species of mammals. The herd management invention utilizes isolated populations of X-chromosome bearing spermatozoa (some portion of the Y-chromosome bearing spermatozoa population has been removed to enrich the ratio of X-chromosome bearing spermatozoa to X-chromosome bearing spermatozoa in the total spermatozoa population). By utilizing isolated populations of X-chromosome bearing spermatozoa (as many as 98 of 100 spermatozoa bearing an X-chromosome) to artificially inseminate females (17) in the herd, female offspring can be produced to replace substantially all (or the number desired) of the females (17) harvested from the herd (20). As such, in certain embodiments of the invention each female (17) can have a single parturition prior to being harvested (20). The herd management invention can further comprise the practice of induced early puberty. Early puberty can be induced by generating rapid weight gain in the mammal. As disclosed in further detail by Example 1, puberty can be induced in beef cattle as early as between about 250 days after birth to about 270 days after birth. A weight gain of about 1.3 kilograms per day to about 1.4 kilograms per day per head can be sufficient to induce early puberty. By inducing early puberty artificial insemination estrous synchronization (24) and artificial insemination (27) and can be performed at an earlier time in the herd management cycle. To further shorten the time between birth and harvest of the animal while allowing at least one parturition for replacement, the female mammal can be early weaned as described above. In a beef cattle embodiment of the invention a female can be born, weaned at between about 95 to about 125 days, estrous synchronized at between about 250 to about 280 days, artificially inseminated, calve about 9 months later and be harvested prior to 24 months.

While FIG. 7, provides a specific time line for beef cattle embodiment of the herd management invention, it is understood that is illustrative of the broad variety of species of mammal that can be managed in a similar fashion and the specific example and time line provided is not intended to limit the invention to that specific example of that time line.

Now referring to FIG. 8, an exemplary estrous synchronization protocol for beef cattle is provided in which cattle feed is top dressed with MGA at 0.5 milligrams per female animal per day for 14 days. On day 33, each female animal is injected with PGF2α. Three days subsequent, each female is artificially inseminated.

### EXAMPLE 1

An integrated herd management system (IS) was designed to evaluate integration of early weaning and use of sexed semen in a single calf heifer (SCH) system to increase value of non-replacement heifers. The project consisted of five phases; Phases I, II, and III were developmental stages of the heifers. Phase IV was a qualitative measurement of the integrated system where carcass evaluation occurred. Phase V determined economic status of the integrated system. The integrated IS may be an alternative to the traditional marketing (TMS) of non-replacement heifers. Traditional marketing of non-replacement heifers is defined as the sale of TMS heifers on live-weight bases immediately following >traditional=weaning at age of approximately 7 months (200 days). Therefore, the IS is economically compared to the TMS. The IS incorporates reproductive factors such as puberty and breeding of heifers; therefore, replacement heifer counterparts meant for reproduction and managed in a traditional replacement system (TRS) are compared to the IS heifers for these factors only.

Colorado State University's Eastern Colorado Research Center at Akron, Colo. was the site for research. The project began July of 1999 (YI) with a replication that began August 2000 (YII). Data are presented for all phases of YI but stop after PI in YII as research beyond that point had not been completed. Heifers from the Red Angus X Hereford ECRC herd were divided into two treatment groups. Heifers in the IS were of non-replacement status, particularly those born in the last half of the calving season but no younger than 55 d of age on the date of early weaning. These heifers were early weaned, fed a high energy diet to promote rapid growth of approximately 1.6 kg/d in order to reach 65% of mature weight (determined to be 500 kg by data from herd dams) by 9 mo of age. The IS heifers were mated at approximately 10 mo of age and harvested by 24 mo of age (Table 1). All other heifers of replacement status were managed in the ECRC replacement heifer system, weaned at approximately 7 mo of age, developed on range, and mated at 14 mo of age.

TABLE 1
Timeline of research, date of each phase and corresponding
age of Integrated System heifers.

| | Year I | | Year II | |
|---|---|---|---|---|
| Phase I¹: | | | | |
| Weaning- | | | | |
| Breeding | | | | |
| Age in (d) | 109 ± 15.0 | 0/7/28/1999 | 116 ± 10.5 | 08/07/2000 |
| Age out (d) | 322 ± 15.0 | 02/26/2000 | 316 ± 10.5 | 02/27/2001 |
| Days on feed | 213 | | 200 | |
| P1 | | | | |
| Phase II²: | | | | |
| Breeding- | | | | |
| Calving | | | | |
| Age in (d) | 320 ± 12.7 | 02/26/2000 | 316 ± 10.5 | 02/27/2001 |
| Age out (d) | 573 ± 12.7 | 11/8/2000 | — | — |
| Total days | 253 | | — | — |
| Phase III²: | | | | |
| Calving- | | | | |
| Harvest | | | | |
| Age in (d) | 573 ± 12.7 | 11/8/2000 | — | — |
| Age out (d) | 719 ± 12.7 | 04/05/2001 | — | — |
| Total days | 146 | | — | — |

¹Data based on original Integrated System heifers on study.
²Data based on final 22 hd of Integrated System heifers. These heifers conceived, were fed to finish and harvested. Data reported for Year I only as Year II data not yet collected.

Phase I: Weaning of Heifer to Breeding of Heifer

Weaning

The first year's (YI) experimental group consisted of 46 IS heifers that were weaned at a non-traditional early age of 110″ 15.0 d and 40 TRS heifers were weaned at a traditional weaning age of 229″ 2.8 d. The second year's (YII) experimental group consisted of 48 IS heifers weaned at an average age of 115″ 26.9 d and 48 TRS heifers traditionally weaned and weighed at 174″ 21.2 days of age. Body weight of heifers was recorded at each weaning date. Body condition scores (9-point scale) of the dams were recorded at the time of early weaning in YI and YII then again at the time of traditional weaning.

Nutritional Management

Dams of the heifers were managed on native range in two separate pastures in YI. Dams of the TRS heifers were allowed winter supplementation whereas dams of the IS heifers were not. The dams were managed in this manner to allow evaluation of an early-weaning program on winter feed expenditures. Weaning strategy had an affect dam BCS at time of TW, where the dams of the EW calves had greater BCS than the dams of the TW calves in YI only. The dams of the IS heifers were managed without supplementation as body reserves were adequate enough to allow the dams to lose body condition without risk of health or production loss. The dams of the TRS heifers were managed to allow body weight gain or maintenance. The dams were combined at the end of the winter season at similar body weights and condition. However, in YII, the dams were not managed separately as in YI because BCS of dams were equal at time of TW. Drought conditions limited forage quality and availability to dams; hence, weaning of the TRS occurred 55 d earlier than TW of TRS in YI. The combined effect of drought conditions and shorter duration of lactation of the dams of the TRS heifers in YII may explain lack of BCS difference between dams of IS heifers and dams of TRS heifers. Equal body weights did not allow any contrast between weaning strategies according to winter supplementation and therefore eliminated the need to manage dams separately. Pasture lease and feed cost for dams were analyzed.

Traditional replacement system heifers were managed on triticale pasture with access to native range in YI. In YII, TRS heifers were managed in dry lot conditions due to insufficient grass on native range resulting from drought conditions. Dry lot ration was balanced according to NRC (68) and included whole shelled corn, millet hay, and alfalfa hay. Nutritional values for triticale (63) and native range (19) and are listed in Tables 2,3, and 4. Nutritional values are based on 100% inclusion in the diet as amount of each forage in the diet can not be established, however, triticale was likely the main source of nutrition. Ration samples of the IS heifer diets were periodically collected throughout Phase I and III and analyzed by Olsen's Laboratory McCook, Nebr. (FIGS. 1,2,3 and 4).

TABLE 2
Seasonal trends of intake, crude fiber, and crude protein of native range plants as evaluated by clippings^{a}.

| | | | | | | | Blue Grama | | | | | |
|---|---|---|---|---|---|---|---|---|---|---|---|---|
| | Prairie Sand Reed | | | Sand Bluestem | | | | | Crude | Sun Sedge | | |
| | % Diet | Crude | Crude | % Diet | Crude | Crude | % Diet | Crude | Protein | % Diet | Crude | Crude |
| | (DM) | Fiber % | Protein % | (DM) | Fiber % | Protein % | (DM) | Fiber % | % | (DM) | Fiber % | Protein % |
| Oct-Nov | 1 1 | 38.2 | 2.8 | 0.5 | 32.4 | 3.7 | 31 | 25.5 | 5 | 1 | 30.5 | 6.1 |
| Dec | 1 | 36.8 | 2.5 | 0 | 33 | 3.5 | 71 | 29 3 | 4 | 1 | 32.15 | 5 6 |
| Jan | 3 5 | 37 | 2.6 | 0.5 | 34.9 | 3.7 | 73.5 | 29.95 | 3.7 | 2 | 31.9 | 5.5 |
| Feb | 2.5 | 35.7 | 2.8 | 0.5 | 35 | 2.8 | 62.5 | 31.15 | 4.2 | 1 | 27.4 | 6.8 |
| March | 4 5 | 39 15 | 2.5 | 0 | 38.5 | 3.8 | 37 5 | 30.9 | 5 | 1.5 | 24 35 | 5 7 |
| April | 4 | 38 | 3 | 0 | 35 5 | 4 3 | 13 | 27.15 | 5 | 1 | 28.3 | 9.3 |
| May | 0 3 | 33.65 | 16.6 | 0 | 35.6 | 4.5 | 0.4 | 29.1 | 7 | 1.5 | 24.1 | 14 |
| June | 68 | 35.3 | 13.6 | 3.8 | 30.9 | 12.8 | 0.5 | 28.7 | 10.2 | 9.1 | 22.45 | 12.6 |
| Late June | 64 | 38 27 | 11 | 14 | 36.48 | 10.9 | 2 | 30 32 | 8.5 | 0 | 27.29 | 10.5 |
| July | 75 | 35.69 | 7.7 | 12 | 33.16 | 9 | 7 | 30.32 | 7.9 | 1 | 27.71 | 9.6 |
| Aug | 66 | 36 73 | 7.2 | 9 | 29 37 | 7.9 | 14 | 30.63 | 7.5 | 0 | 27 43 | 8.4 |
| Sept | 32 | 35.41 | 6.3 | 22 | 31 46 | 6.4 | 35 | 30.71 | 5 | 1 | 28.03 | 67 |
| Late Sept | 34 | 35.13 | 6.1 | 0 | 30.76 | 5 9 | 43 | 30.91 | 4.3 | 0 | 28.42 | 5.7 |
| Oct | 1 | 31.02 | 3 4 | 0 | 33 23 | 3 6 | 39 | 32.47 | 3 1 | 2 | 29.95 | 5 4 |
| | | | | | | | Forbs | | | | | |
| | Needle-and-thread | | | Western Wheatgrass | | | | | Crude | Other | | |
| | % Diet | Crude | Crude | % Diet | Crude | Crude | % Diet | Crude | Protein | % Diet | Crude | Crude |
| | (DM) | Fiber % | Protein % | (DM) | Fiber % | Protein % | (DM) | Fiber % | % | (DM) | Fiber % | Protein % |
| Oct-Nov | 56.5 | 35.3 | 4.8 | 2 | 35 6 | 3.2 | 6 | 25.2 | 6.5 | 2 | — | — |
| Dec | 21 | 34.8 | 4.3 | 4 | 33.45 | 2.2 | 1 | 28.3 5.4 | 1 | — | — | |
| Jan | 16.5 | 36.85 | 34 | 0 | 33.65 | 2 7 | 1 | 26 85 | 5.1 | 3 | — | — |
| Feb | 26.5 | 33 15 | 3.7 | 2 | 27.65 | 3.2 | 1 | 27 | 56 | 4 | — | — |
| March | 35.5 | 34.55 | 3.8 | 18.5 | 33.1 | 4.4 | 0 | 29.2 | 4.7 | 2 5 | — | — |
| April | 61 | 29.8 | 8.2 | 21 | 33.3 | 7.1 | 0 | 31 6 | 8 | 0 | — | — |
| May | 33 | 28 7 | 12 3 | 63.2 | 24.9 | 17.3 | 0.4 | 22.6 | 18 8 | 1.2 | — | — |
| June | 10 9 | 31.85 | 10 5 | 0 5 | 35 | 12.5 | 2.6 | 20.1 | 19.8 | 4 6 | — | — |
| Late June | 4 | 36.01 | 8.3 | 10 | 34.3 | 14.1 | 4 | 25.36 | 12.9 | 2 | — | — |
| July | 2 | 33 | 8.8 | 1 | 31.85 | 12.8 | 1 | 25.1 | 14 | 1 | — | — |
| Aug | 2 | 32.3 | 95 | 0 | 29 7 | 11.4 | 1 | 23.39 | 11.6 | 8 | — | — |
| Sept | 1 | 34 04 | 6 3 | 0 | 29.6 | 8.1 | 3 | 20 95 | 10.2 | 6 | — | — |
| Late Sept | 6 5 | 33 83 | 6.2 | 7 | 25.2 | 9.9 | 6.5 | 18 44 | 10.2 | 3 | — | — |
| Oct | 45 | 33.6 | 5.3 | 9 | 29 3 | 6 | 3 | 23.7 | 6.6 | 1 | — | — |

^{a}Denham (1965).

TABLE 3
Seasonal trends in crude protein and TDN content
of triticale forage as evaluated by clippings^{a}.

| | Crude Protein | TDN |
|---|---|---|
| | (%) | (%) |
| February | 21.1 | 74.2 |
| June | 19.4 | 75.3 |

^{a}Mount (2000).

[image]

[image]

The IS heifers were managed in feedlot immediately following weaning and continuing for 213 d and 200 d in YI and YII, respectively. Self-feeders were utilized for 140 days in YI and 5 d in YII then bunk-fed for the remainder of Phase I (73 d YI and 195 d YII). The duration of self-feeders utilized in YII was limited due to sickness and necessity to administer medicated feed. The ingredients of the feedlot ration YI included triticale grain, sunflower meal pellet, corn ground alfalfa, protein supplement and Rumensin7. Ingredients of the feedlot ration in YII were similar to YI with the exclusion of sunflower meal pellet. Weight of the EW heifers was measured every 28 d and the ration evaluated and adjusted according to heifer gain. The most important goal of the feeding strategy was for IS heifers to reach 65% of mature weight (based on herd of origin mature weight of 500 kg) by 9 mo of age to induce an early puberty. Therefore each 28 d interval had a goal of 1.36 kg/day gain until heifers began to cycle. At this point the ration energy density was reduced to prevent over fattening and possible subsequent reproduction/calving difficulties. Daily individual intake was calculated by dividing pen intake by total animals in the pen (FIGS. 5 and 6). Rations were balanced according to NRC (68) requirements for growing/finishing calves at 1.3 kg/d gain.

[image]

[image]

Heifers that had poor gains and/or exhibited chronic morbidity were culled from the system. Culled heifers were sold at a local livestock auction at market price. Mortality of heifers was accounted for in the economic analysis. Weight of dead animals was estimated according to the group average. A dollar value of the dead animals was calculated by market purchase price of an animal of similar weight and age.

Monitoring Onset of Puberty

Onset of puberty and estrous was monitored by behavioral and physiological indicators. The DDx Electronic Heat Watch7 system with the aid of 3 (YI) and 1 (YII) androgenized cows monitored behavioral patterns and the onset of standing heat via mount duration and frequency (96). Androgenization was accomplished by methods described by Nix et al. (67). Androgenization of cows was conducted due to the hypothesis that androgenized cows have a similar effect on enhancing puberty through pheromonal cues as hypothesized for bulls. Jugular blood samples of IS heifers were taken at 10 d intervals for a period of 2 mo (YI) and 3 mo (YII) prior to MGA/PGF synchronization and again 10 d prior to and on day of PGF injection (FIG. 7). Serum samples were analyzed for progesterone by radioimmunoassay (21). Percent of TRS heifers at puberty was also measured by progesterone assay for one month prior to MGA/PGF synchronization of the IS heifers. Heifers were considered pubertal when serum progesterone concentration was greater than 1 ng/ml within a 10 d period (7).

[image]

Synchronization and Artificial Insemination of IS Heifers

The IS heifers underwent estrous synchronization accomplished by top dressing feed with 0.5 mg MGA per hd/d for 14 d followed by PGF injection 19 d after the last day of MGA feeding as described by Deutscher (20). Heifers were synchronized at 250″ 15.0 d of age YI and 250″ 14.9 d of age YII. Heifers were AI by one of two technicians following standing estrus up to 72 h post PGF injection according to a.m./p.m. protocol. At 72 hr post PGF injection, all remaining pubertal heifers were mated at a fixed-time. A breeding period of 45 d (YI) allowed heifers three or four opportunities to be AI and 24 d (YII) allowed 2 matings. All rebreeds were based on standing heat recorded by Electronic Heat Watch7 and/or visual observation and bred according to a.m./p.m. protocol.

Semen used for artificial insemination was collected from two Black Angus bulls (YI) and one Black Angus bull (YII) with low birth weight EPD of 0.5, 1.5 and B 1.43, YI and YII, respectively. Semen was sorted using flow cytometry, selected for X-chromosomal sperm (82). Semen doses for insemination contained three million sperm (YI) and six million sperm (YII) per dose with at least 35% post thaw motility.

During YI, heifers were fixed-time mated with sexed semen, randomly AI with one of two sires as determined by random order of the heifers entering the breeding box; sires were alternated with every heifer. Heifers that required a second mating were inseminated with sexed semen from the same sire used in the fixed-time mating. Heifers that required a third mating were randomly inseminated with either sexed or non-sexed semen by one of two sires. Non-sexed semen was used to mate 6 IS heifers and was a breech of protocol. Seven IS heifers exhibited a fourth standing heat during the 45 d breeding season, 1 heifer was mated to sexed semen and the remaining 6 heifers were mated by natural service of a bull. Likewise, natural service with a bull was a breech of protocol.

The YII IS heifers were fixed-time mated to one sire to minimize variation of progeny. Protocol for the second breeding season called for one-third of the YII IS heifers to be inseminated with non-sexed semen and the remaining ⅔ inseminated with sexed semen to compare fertility of sexed versus non-sexed semen. Mating of the heifers to non-sexed versus sexed semen was determined by random order of the heifers entering the breeding box; every third heifer was bred to non-sexed semen. Likewise, ⅓ of the heifers that required subsequent breeding called for insemination with non-sexed semen; the remaining heifers were inseminated with sexed semen. The final result is that fixed-time insemination of IS heifers was done with 25.4% of heifers mated to non-sexed semen; the remaining 74.6% of heifers were mated to sexed semen. After 24 d of the breeding season, 28.6% of heifers were inseminated with non-sexed semen and the remaining 71.4% were inseminated with sexed semen.

Diagnosis of Pregnancy

First service conception rate was determined by ultrasonography 34 d and 45 d post fixed-time mating in YI and YII respectively. Overall conception and pregnancy rates were also determined by ultasonography 34 d and 60 d following the last date of insemination for YI and YII respectively. Heifers diagnosed non-pregnant were culled from the system and the remaining pregnant heifers went on to Phase II. Culled heifers in YI were sold at market price to the ECRC feedlot. Revenue created by this sale was accounted for in PI and used in the final economic analysis.

Phase II: Breeding to Calving (YI IS heifers)

Nutritional Management

The IS heifers were turned on to native range at an average age (calculated from the final 22 IS heifers) of 297″ 12.6 days of age. The heifers remained on pasture for 237 days at which time the first IS heifer gave birth (534″ 12.6 d of age). Weight of IS heifers were recorded on the first and last day of this phase. Forage nutritional values are reported in Tables 2 and 4 (19).

TABLE 4
Seasonal trends in crude
fiber and crude protein of native range clippings as a result of variable seasonal intakes^{a}.

| | | | | | | | | Year I, Phase II | | | | | | | | | | | |
|---|---|---|---|---|---|---|---|---|---|---|---|---|---|---|---|---|---|---|---|
| | Year I, Phase I | | | | | | | | | | | Year II, Phase II | | | | | | | |
| | | Late | | Oct- | | | | | | | | Late | | | | Late | | Oct- | |
| | Sept | Sept | Oct | Nov | Dec | Jan | Feb | Mar | Apr | May | June | June | July | Aug | Sept | Sept | Oct | Nov | Dec |
| % Diet | 100 | 100 | 100 | 100 | 100 | 100 | 100 | 100 | 100 | 100 | 100 | 100 | 100 | 100 | 100 | 100 | 100 | 100 | 100 |
| (DM) | | | | | | | | | | | | | | | | | | | |
| Crude | 30.25 | 30 40 | 32.04 | 30.96 | 30.42 | 30.47 | 30.42 | 32.10 | 30.50 | 25 88 | 31 53 | 36.09 | 34.38 | 32.05 | 30.25 | 30.40 | 32.04 | 30 96 | 30.42 |
| Fiber % | | | | | | | | | | | | | | | | | | | |
| Crude | 5.61 | 5.68 | 4.47 | 4.83 | 3.97 | 3.55 | 3.88 | 4 24 | 7.36 | 15.36 | 12 65 | 10.99 | 7 95 | 6.82 | 5.61 | 5.68 | 4.47 | 4.83 | 3 97 |

^{a}Adapted from Denham (1965)

Back-fat Measurements

Back-fat thickness was measured by ultrasound for the IS heifers 20 d prior to first date of calving and again 20 d following calving. Back-fat was measured between the 12^{th} and 13^{th} rib at: the distance of the ribeye with an Aloka 500 V ultrasound machine.

Calving Management

The IS heifers calved in dry lot conditions. Heifers were observed every 4 hours during the calving season. Heifers received assistance from the calving manager if calf presentation or parturition progression was abnormal or unsatisfactory. Calving ease, calf vigor, calf birth-weight, sex, mortality and morbidity were documented. Calving ease and calf vigor scores are reported as follows: calving ease: 1=no assistance, 2=assisted, easy, 3=assisted, very difficult, 4=caesarean delivery, 5=breech birth, abnormal presentation: calf vigor 1=nursed immediately, calf was healthy and strong, 2=nursed on its own, but took some time, 3=required some assistance to suckle, 4=died shortly after birth, 5=dead on arrival.

In YI abortion occurred in 4 of the 25 IS heifers bred (16%). These IS heifers experienced early fetal loss and three were rebred by natural service as a result of IS heifers commingling with the normal herd during breeding season. These IS heifers were culled from the IS and sold as bred heifers at the local livestock auction in Yuma, Colo. Revenue ($650.00 per IS heifer) from these late-bred IS heifers was received by the IS and is included in the economic analysis. The forth IS heifer that experienced fetal loss did not rebreed and was kept in the IS, finished and harvested with her pregnant IS heifer counterparts.

Phase III: Calving to Slaughter

Nutritional Management

The IS heifers were placed on feedlot ration at 534″ 12.6 d of age until 696″ 12.6 d of age for 162 d. Ingredients included triticale grain, whole shell corn, and alfalfa (FIG. 3 and 4). The ration was balanced according to NRC (68) requirements for lactating 550 kg cows and adjusted according to IS heifer and calf performance. Daily intake was calculated by dividing group intake by the number of animals in the pen (FIG. 8). Integrated system heifer and IS calf weight was recorded every 28 d.

Weaning

Calves born to the IS heifers were weaned at 120″ 19.6 d of age and marketed at a local livestock auction immediately following weaning. Revenue from the calves was accounted for in the final economic analysis.

Determination of Harvest

IS heifers remained in feedlot for 141 d and harvested at 696″ 12.6 d of age d (23 mo) of age. Integrated System heifers were considered market ready according to estimated visual backfat depth of 1.27 cm. The time from weaning to harvest was 21 d to allow adequate time for udder to cease lactation and undergo involution.

Phase IV: Carcass Evaluation

Marketing of IS heifers

The final 22 IS heifers were marketed on formulated price according to carcass quality (live-weight, USDA Quality Grade and USDA Yield Grade). Premiums and discounts associated with the grid are listed in Table 5.

TABLE 5a
Formulated pricing* of Year I Integrated System heifer carcasses expressed in market terms ($/cwt).

| | | Prime | Choice | Select | Standard | Commercial | Utility | Canner | Dark Cutter | B-Maturity |
|---|---|---|---|---|---|---|---|---|---|---|
| BASE | $127.01 | 6.97 | $0.97 | ( 37) | ( $7) | ($25.00) | ($25.01) | ($25.01) | ($22.84) | ($10.87) |
| 1 | $3.00 | 136.98 | 130.98 | 128.14 | 118.14 | 105.01 | 55 00 | 55.00 | 107.17 | 118.14 |
| 2 | $1.50 | 135.48 | 129.48 | 126.64 | 116.64 | 103.51 | 53.50 | 53.50 | 105.67 | 116.64 |
| 3 | $.50 | 132.98 | 126.98 | 124.14 | 114.14 | 101.01 | 51.00 | 51.00 | 103.17 | 114.14 |
| 4 | ($0.00) | 113.98 | 107.98 | 105.14 | 95.14 | 82.01 | 32.00 | 32.00 | 84.17 | 95.14 |
| 5 | ($22.06) | 108.98 | 102.98 | 100.14 | 90.14 | 77.01 | 27.00 | 27.00 | 79.17 | 90.14 |

*Formulated pricing per hundred lb.

TABLE 5b
Formulated pricing* of Year I Integrated System heifer carcasses expressed in metric terms ($/100 kg).

| | | Prime | Choice | Select | Standard | Commercial | Utility | Canner | Dark Cutter | B-Maturity |
|---|---|---|---|---|---|---|---|---|---|---|
| BASE | $280.01 | $15.37 | $2.14 | ($4.02) | ($26.17) | ($55.02) | ($65.37) | ($65.27) | ($56.85) | ($26.27) |
| 1 | $6.61 | 301.99 | 288.76 | 282.50 | 260.45 | 231.51 | 121.25 | 121.25 | 236.27 | 260.45 |
| 2 | $3.31 | 298.68 | 285.45 | 279.19 | 257.15 | 228.20 | 117.95 | 117.95 | 232.96 | 257.15 |
| 3 | ($2.20) | 293.17 | 279.94 | 273.68 | 251.64 | 222.69 | 112.44 | 112.44 | 227.45 | 251.64 |
| 4 | ($44.09) | 251.28 | 238.06 | 231.79 | 209.75 | 180.80 | 70.55 | 70.55 | 185.56 | 209.75 |
| 5 | ($55.12) | 240.26 | 227.03 | 220.77 | 198.72 | 169.78 | 59.52 | 59.52 | 174.54 | 198.72 |

*Formulated pricing per hundred kg.

Carcass Data Collected

Carcasses were tracked from the kill floor to the cooler on the day of harvest. Approximately 36 h postmortem, USDA Quality Grade factors (skeletal maturity, lean maturity and marbling) and USDA Yield Grades (longissimus muscle area, hot carcass weight, and estimated percent of kidney pelvic and heart fat) were recorded (103). Strip loins were collected from each IS heifer carcass. Loins were taken to Colorado State University, aged for 14 days at 2EC then frozen (−29E C) until strip loin sections were sawed into steaks (2.54 cm thick).

Trained Sensory Evaluation and Warner-Bratzler Shear Force Values

Strip loins were removed from the freezer cut into 2.54 cm steaks which were then thawed in a refrigerated cooler (4EC) for 24 hrs. Steak temperature was monitored to ensure steak temperatures were between 1EC and 5EC immediately prior to cooking. Steaks were cooked to 70EC internal temperature using a Magikitch=n belt grill (Magigrill model TBG-60; Magikitch=n Inc., Quakertown, Pa.); (top heat=177EC, bottom heat=177EC, preheat=disconnected, height=1.85 cm, cook time=6.55 min). Final endpoint temperatures were monitored using a handheld thermometer (Omega model HH21 thermometer; Omega Engineering, Inc., Stamford, Conn.). Cubed samples of each cooked steak were served to a sensory panel. Panelists were trained for two weeks according to procedures outlined by Meilgaard et al. (57) and AMSA (3). Panelist scored the samples for juiciness, muscle fiber tenderness, overall tenderness, connective tissue and amount of flavor intensity using an 8-point scale (3).

Steaks for the Warner-Bratzler shear force values were handled and prepared in the same manner as stated above. The steaks were allowed to cool to room temperature (24EC) before removing six to ten cores (1.27 cm in diameter) parallel to the steak muscle fiber (3). Each core was sheared once using Warner-Bratzler shear machine. Individual peak shear force values were averaged to obtain a final representative shear force value for each steak. The WBS threshold of 4.5 kg determined carcass classification of tough or tender (89). Carcasses with WBS values greater than 4.5 kg were considered “tough”, whereas carcasses with WBS values less than 4.5 kg were considered “tender”.

Phase V: Economic Analysis

Total income and expenditures were recorded for each phase. Gross revenue/loss and net revenue/loss were calculated for each phase as well as final gross revenue/loss and net revenue/loss for all phase (Tables 14-19). Revenue/loss was reported for the entire system as well as revenue/loss per heifer. Economic analysis compared a traditional management system of non-replacement females to the IS. An additional simulation were conducted to compare and contrast effect of increased pregnancy rate (58%, 60%, 70%, 80%, 90% and 100%) and calf survival (88%) on profitability of the IS.

Phase I

In PI, IS heifers were purchased into the system according to the seasonal live-weight markets in the area ($103.00/cwt) (Table 14). Cull cows were purchased at market price, and androgenized to aid in heat detection. These cull cows were later sold on live-weight basis; prices reported are actual prices received. Integrated System heifers were realized from the system due to poor performance and sold at seasonal live-weight market price for the area. Economic loss due to death was considered equal to purchase price multiplied by weight of IS heifer at death. Dead IS heifers were assigned a weight based on the group average weight at the time of death.

TABLE 14
Income statement for Year I Phase II.

| | # Head | | | |
|---|---|---|---|---|
| REVENUES | Weight (cwt) | Total | | |
| Cull Open IS Heifer | 18 | 10 | $66.00 | $11,880.0 |
| GROSS INCOME | | | | $11,880.0 |
| EXPENSES | | | | |
| Pasture | # Head Lease/AUM | Months Total | | |
| | 43 | $13.00 | 1.4 | $508.6 |
| S Heifer (.65 AUM) | 25 | $13.00 | 6.4 | $1,352.0 |
| TOTAL | | | | $1,860.6 |
| TOTAL OPERATING EXPENSE | | | | $1,860.6 |
| NET REVENUE/LOSS (Income-expenses) | | | | $10,019.3 |

Feed cost was calculated by multiplying the cost of feed per ton by the total amount of feed consumed. Cost of feed per ton was marked up 10%. Yardage was charged at a rate of $0.20 per head per day. Health costs included initial processing; hospital drugs administered to sick animals and associated chute charges of $1.00/hd. Breeding costs were calculated by adding the total cost of synchronization drugs to the cost of semen, semen sorting fees, and technician wages. Gross revenue/loss for PI was calculated by subtracting the total expenditures from the total income and value of IS heifers remaining in the system.

Breeding costs were calculated by summing cost of insemination and synchronization. Cost of insemination was calculated by multiplying the total number of inseminations by technician fee ($4.00/insemination), sorting fee for semen ($20.00/straw), and semen ($12.00/straw). Synchronization drugs included MGA ($1.96/hd) and prostaglandin ($2.10/hd) for 43 head of IS heifers.

In YI, cost of maintenance for dams of TMS heifers and for IS heifers was calculated by adding the pasture lease cost to supplemental feed cost. The difference between the two groups winter feed cost was calculated.

Phase II

Phase II gross and net revenue/loss was calculated by multiplying pasture lease cost by 0.65 AUM per month at a rate of $13.00/AUM (Table 15). All heifers were moved into PII for 1.4 mo, however only the 25 pregnant IS heifers remained in the PII for the duration of 253 d. Revenue generated from sale of open IS heifers are accounted for in this phase.

TABLE 15
Income statement for Year I Phase III.

| REVENUES | | | | |
|---|---|---|---|---|
| | # Head | Ave WT | Market Price | Total |
| Cull Bred IS Heifers | 3 | | $650.00 | $1,950.00 |
| Lightweight IS calf | 1 | 1.2 | 100 | $120.00 |
| Heavyweight IS calf | 13 | 3.3 | $122.00 | $5,233.80 |
| Finished IS Heifer | 22 | | | $21,510.53 |
| TOTAL | | | | $28,814.33 |
| GROSS INCOME | | | | $28,814.33 |
| EXPENSES | | | | |
| Livestock | # Head | Ave WT | Market Price | Total |
| Death Loss of | 6 | 3.3 | $122.00 | $2,415.60 |
| IS Calf | | | | |
| TOTAL | | | | $2,415.60 |
| Feed | # Head | Intake (ton) | Price/ton | Total |
| Corn | 22 | 41.101 | $82.50 | $3,390.83 |
| Millet Hay | | 1.533 | $62.50 | $95.81 |
| Alfalfa Hay | | 8.52 | $120.00 | $1,022.40 |
| Medicated Feed | | 0 | $120.00 | $0.00 |
| Supplement 517 | | 4.227 | $205.00 | $866.54 |
| Markup | | 55.382 | $15.00 | $830.73 |
| TOTAL | | | | $6,206.31 |
| Yardage | # Head | Rate | #Head Days | Total |
| Head In | 22 | $0.30 | 3212 | $963.60 |
| Dead | 0 | $0.30 | 0 | $0.0 |
| Realized | 0 | $0.30 | 0 | $0.0 |
| TOTAL | 22 | | 0 | $963.60 |
| Health | # Head | Rate | | Total |
| Processing | 46 | $1.00 | | $46.00 |
| Hospital drugs | | | | $0.0 |
| Chute Charge | | | | $0.0 |
| TOTAL | | | | $46.00 |
| Marketing | # Head | Rate | | Total |
| Transportation | 22 | 12.95 | | $284.90 |
| Brand Inspection | 22 | 1.45 | | $31.90 |
| TOTAL | | | | $316.80 |
| TOTAL | | | | $9,948.31 |
| OPERATING | | | | |
| EXPENSE | | | | |
| NET REVENUE/ | | | | $18,866.02 |
| LOSS | | | | |
| (Income-expenses) | | | | |

Phase III economic analysis resembled PI for health costs and feed cost. Yardage was increased to $0.30 per head per day as a result of increased labor associated with calves of IS heifers (Table 16). Cull cattle included IS heifers that were bred late and marketed as bred heifers. Prices reported are actual prices received from sale. Calves of the IS heifers were sold immediately following weaning on a live-weight basis. Prices reported are actual prices received. Prices reported for the remaining IS heifers were received upon marketing of heifers according to carcass merit (Tables 5 and 17). Gross revenue/loss was calculated by subtraction of total expenditures from total income. Overall gross and net revenue/loss was calculated by summing gross and net revenue/loss from each phase respectively.

TABLE 16
Results of formulated pricing of YI Integrated Heifer Carcasses, shown in price per 100 kg and price per 100 lbs.

| | Price | | Wt | | | Price | | Wt | |
|---|---|---|---|---|---|---|---|---|---|
| QG and YG | Per 100 kg | Head | (100 kg) | Total | QG and YG | Per 100 lb | Head | (100 lb) | Total |
| Choice YG 2 | 285.45 | 6 | 21.17 | $6,042.83 | Choice YG 2 | 129.48 | 6 | 46.67 | $6,042 83 |
| Choice YG 3 | 279.94 | 8 | 29.58 | $8,281.64 | Choice YG 3 | 126 98 | 8 | 65.22 | $8,281.64 |
| Choice YG 4 | 238.06 | 1 | 3.79 | $902.23 | Choice YG 4 | 107 98 | 1 | 8 36 | $902 23 |
| Select YG 1 | 282.50 | 1 | 3.41 | $962.33 | Select YG 1 | 128.14 | 1 | 7.51 | $962.33 |
| Select YG 2 | 279.19 | 2 | 6 16 | $1,719.77 | Select YG 2 | 126.64 | 2 | 13.58 | $1,719.77 |
| B-Mat YG2 | 257 15 | 2 | 6.87 | $1,767.10 | B-Mat YG2 | 116.64 | 2 | 15 15 | $1,767 10 |
| B-Mat YG3 | 251 64 | 1 | 3.85 | $967.91 | B-Mat YG3 | 114 14 | 1 | 8.48 | $967.91 |
| B-Mat YG4 | 209.75 | 1 | 4.13 | $866.73 | B-Mat YG4 | 95.14 | 1 | 9.11 | $866.73 |
| TOTAL | | | | $21,510 53 | TOTAL | | | | $21,510.53 |

TABLE 17
Comparison of net revenue of the Integrated System to
Traditional Management System of non-replacement heifers.

| Integrated Heifer System | |
|---|---|
| Gross Revenue | $43,285.81 |
| Expense | $43,200.97 |
| NET REVENUE/LOSS (Income-expenses) | $84.84 |
| Traditional Management System | |
| Gross Revenue¹ | $21,834.80 |
| Expense² | $19,352.58 |
| NET REVENUE/LOSS (Income-expenses) | $2,482.22 |
| Difference between Systems (IS-TMS) | ($1,944.67) |

¹Gross Revenue calculated by multiplying average weaning weight of traditional weaned calves in YI by market price of $88.00/cwt.
²Expense is equal to the five-year average of cow cost of the ECRC herd.
³Prices based on 43 head of heifers.

Difference in Profitability Between TMS and IS

Profitability of the IS over the TMS was calculated by subtracting the net revenue of the TMS from net revenue of the IS (Table 18). Gross revenue/loss for TMS was calculated by multiplying the average weaning weight of the TMS heifers at the time of traditional weaning by a seasonal live-weight market price for the area ($88.00/cwt).

TABLE 18
Revenue of Integrated System as a function of pregnancy rate.

| Pregnancy | Total | | | | |
|---|---|---|---|---|---|
| Rate | Pregnant | | Total | Revenue/Heifer | Revenue/Pregnancy |
| 58% | 25 | PI | $(28,800.49) | $(626.10) | $(1,152.02) |
| | | PII | $10,062.15 | $218.74 | $402.49 |
| | | PIII | $26,447.21 | $574.94 | $1,057.89 |
| | | Total | $7,708.87 | $167.58 | $308.35 |
| | | Revenue above | | | |
| | | TMS | $3,679.36 | $85.57 | $147.17 |
| 60% | 26 | PI | $(28,800.49) | $(626.10) | $(1,116.30) |
| | | PII | $9,448.05 | $205.39 | $366.20 |
| | | PIII | $27,392.41 | $595.49 | $1,061.72 |
| | | Total | $8,039.96 | $174.78 | $311.63 |
| | | Revenue above | | | |
| | | TMS | $4,010.46 | $93.27 | $155.44 |
| 70% | 30 | PI | $(28,800.49) | $(626.10) | $(956.83) |
| | | PII | $6,377.50 | $138.64 | $211.88 |
| | | PIII | $32,118.41 | $698.23 | $1,067.06 |
| | | Total | $9,695.42 | $210.77 | $322.11 |
| | | Revenue above | | | |
| | | TMS | $5,665.91 | $131.77 | $188.24 |
| 80% | 34 | PI | $(28,800.49) | $(626.10) | $(837.22) |
| | | PII | $3,306.96 | $71.89 | $96.13 |
| | | PIII | $36,844.41 | $800.97 | $1,071.06 |
| | | Total | $11,350.88 | $246.76 | $329.97 |
| | | Revenue above | | | |
| | | TMS | $7,321.37 | $170.26 | $212.83 |
| 90% | 39 | PI | $(28,800.49) | $(626.10) | $(744.20) |
| | | PII | $236.41 | $5.14 | $6.11 |
| | | PIII | $41,570.41 | $903.70 | $1,074.17 |
| | | Total | $13,006.33 | $282.75 | $336.08 |
| | | Revenue above | | | |
| | | TMS | $8,976.83 | $208.76 | $231.96 |
| 100% | 43 | PI | $(28,800.49) | $(626.10) | $(669.78) |
| | | PII | $(2,834.13) | $(61.61) | $(65.91) |
| | | PIII | $46,296.41 | $1,006.44 | $1,076.66 |
| | | Total | $14,661.79 | $318.73 | $340.97 |
| | | Revenue above | | | |
| | | TMS | $10,632.28 | $247.26 | $247.26 |

*Assumes the Integrated System heifer death and realizer rate same as in experimental Year I and calf death rate of 2%.

Simulations

Simulations were conducted to evaluate the effect of pregnancy rate and increased calf survival would have on profitability (Table 19). Simulations varied pregnancy rates at 58% 60%, 70%, 80%, 90% and 100% to evaluate its affect on profitability of each phase and as a system. The pregnancy rate simulations assumed sexed-semen was utilized, 2% calf death loss and IS heifer death loss and realizer rate to be the same as in YI. Further assumptions included all IS calves to sell as >heavy-weight=(330 lbs) and no late-bred IS heifers occurred. Revenue from finished IS heifers based on the percent of each USDA quality and yield grade carcasses received in YI. Feed consumed calculated by multiplying the number of animals in pen average individual intake, based on YI results. All simulations are based on YI actual expenses and incomes.

Statistical Analyse

Statistical analyses were completed using the general linear model (GLM) procedure of SAS (81) and when appropriate, means were separated using Tukey's HSD (81) to determine differences in weights, age, and BCS across years. Logistic regression and contrasts (81) were used with first service or second service resulting pregnancy as the dependent variable; group and heat cycles or group and technician were considered independent variables respectively, to compare and contrast technician, sire, and semen effects within and across years. Group refers to the combination of sexed or non-sexed semen from one of three sires to yield four groups, one sire (YI) with both sexed and non-sexed semen used for insemination of IS heifers, and two sires (YII) with only sexed semen used for insemination of IS heifers. Chi square and correlation analyses (81) were conducted on taste panel characteristics (maturity, session, juiciness, muscle fiber tenderness, presence of connective tissue, overall tenderness, and flavor intensity) and calving characteristics (calf vigor, calving ease, calf sex, and sire). Data collected on animals that died during the trial were not used in the statistical analyses.

Results and Discussion PI:

Early Weaning to Breeding

Integration of early-weaning and sexed semen into a SCH system was studied and a final economic analysis was conducted to establish profitability. In the first year 46 heifers of non-replacement status (IS heifers) were early weaned (EW) at 110 15.0 d of age at 141″ 21.1 kg. Forty heifers of replacement status (TRS) were traditionally weaned (TW) at 229″2.8 d of age at 262″ 25.40 kg. At time of TW, YI IS heifers were 202″ 15.0 d of age and weighed 249″ 6.8 kg. The YI TRS heifers were 27″ 12.2 d of age older (P<0.01), than the YI IS heifers and had greater weights at time of TW. From EW to TW, the dams of the YI IS heifers had greater BCS than dams of YI TRS heifers, 6.6″ 0.80 and 5.8″ 0.78 (P<0.01), as a result of lactation ending and allowing for increased biological utilization of grazing forage nutrition. Myers et al. (64) and Story et al. (97) also reported an increase in dam BCS and subsequent increased reproduction rate of 12% (64). Reproduction rate in the current study was not affected by early weaning as all dams were managed to a constant BCS prior to breeding. The dams of the YI IS heifers were put on winter range without additional supplementation under weight-loss management conditions. The dams of the TRS heifers were also put on winter range managed to maintain or gain BCS. During the winter period, the dams of the YI TRS heifers required very little supplementation due to the mild winter in Akron, Colo. in 1999-2000. Early weaning the YI IS heifers had the very minor economic benefit of $7.06 per dam less wintering cost than the dams of the YI TRS heifers as very little supplement was needed regardless of weaning strategy.

In year two, forty-eight YII IS heifers were weaned at a slightly older age than the first year (P<0.01) 116″ 10.5 d of age and at a greater weight (P<0.01) of 164″ 24.6 kg. Forty YII TRS heifers were traditionally weaned at a younger age (P<0.01) than YI TRS heifers at 174″ 8.0 d of age due to drought conditions and the necessity to conserve range forage for winter consumption by dams. At the time of TW YII IS heifers were 25″ 5.3 d younger than YII TRS (P<0.01) and weighed 190″ 28.9 kg. The YII TRS heifers had equal weights to YII IS heifers at this time. In contrast to YI, EW had no effect on dam BCS from EW to TW (P=0.76) perhaps as a result of TW occurring 55 d earlier than in YII. Hence, dams of the weaned IS heifers did not have adequate time to increase BCS over the lactating dams of TRS between weaning dates. Therefore dams were not managed separately throughout the winter period.

Early weaning heifer calves in this study resulted in increased dam BCS YI as well as faster rates of gain than contemporaries that remained on dam. This is in agreement with Richardson et al. (95), Grimes and Turner (5), and Schoonmaker et al. (85). At the time of traditional-weaning YI and YII IS heifers that were early-weaned were not heavier than the YI and YII TRS heifers that were traditional-weaned as Peterson et al. (70) reported, however, weight per day of age (WDA) was greater for IS heifers than TRS heifers in YI.

The IS heifers 28 d weight gains throughout Phase I varied from 0.86″ 0.371 kg/d to 2.00″ 0.367 kg/d with an overall average of 1.25″ 0.139 kg/d (FIG. 9) in YI. Variation in 28 d weight gains throughout PI in YII were similar to variation in YI, ranging from 0.47″ 0.581 kg/d to 2.45″ 3.804 kg/d with an overall average of 0.81″ 0.155 kg/d (FIG. 9). These variations in 28 d gains are attributed to adjusting feed rations to allow for gains that would induce early puberty via rapid growth of approximately 1.3 kg/d in order to reach 65% of mature weight. Once the heifers began to cycle, the ration was decreased to avoid high BCS of heifers and possible negative impacts on subsequent reproduction/calving difficulty. Negative gains were reported in March of YII PI as a result of a limit fed diet, allowed intake to be approximately 8 kg/hd/d. In addition, YII variation may also be explained by a high morbidity rate of IS heifers throughout PI.

During PI:YI, three IS heifers were taken off the study prior to breeding. One heifer died shortly after weaning due to some unknown cause, the second heifer had poor performance and negative gains, and the third heifer foundered. These losses may have been due to aggressive feeding during the early weaning period and were accounted for in the final economic analysis. Eight heifers were taken off study in the second year due entirely to death loss. Death loss of two heifers occurred shortly after weaning, attributed to respiratory disease. However, the remaining six YII IS heifers perished at various lengths into PI. Death of these heifers was attributed to and diagnosed as enterotoxaemia by a local veterinarian. The outbreak of enterotoxaemia is unexplained as all IS heifers were vaccinated for Clostridium, Type C and D and re-vaccinated after two IS heifers were lost to the disease. It may also be noted that no other feedlot cattle (including herd mates) experienced as great of a mortality or morbidity rate as result of this disease or any other disease. One explanation for high morbidity/mortality of the EW IS heifers may be due to a compromised immune system. At the time of EW, many IS heifers were sick with respiratory infections. It seems as though the IS heifers never really overcame the sickness and can be seen in ADG from EW to TW. These ADG were lower for YII IS heifers than for YI IS heifers despite similar nutritional management (FIGS. 1,2,3 and 4).

Puberty and Breeding

Puberty was reached at various ages dependent on the individual heifer (Table 6). Approximately one month prior to synchronization, YI IS heifers had 20% cycling compared to YI TRS heifers at 8% (P<0.01). The induction of early puberty of the IS heifers can be attributed to nutritional management that allowed greater gains and increased weight at this particular time (P<0.01; 314″ 28.0 kg and 293″ 31.47 kg). At the same time in relation to synchronization, fewer YII IS heifers were cycling compared to YII TRS heifers (P<0.01; 0% and 28%) even though YII IS heifers were heavier (P<0.01; 296″ 32.8 kg and 259″ 43.5 kg); however, the older age of TRS heifers can explain the percent cycling between the two groups (P<0.01; 228″ 10.5 d and 252″ 8.0 d). At this time, fewer YII IS heifers were cycling than YI IS heifers (P<0.01), even though they were older (P<0.01). Perhaps an explanation may be that the YI IS heifers were heavier in weight (P<0.05). Likewise, more YII TMS heifers were cycling (P<0.01) at the same age (P=0.76) but heavier weight (P<0.01). The factors responsible for the differences in percent of heifers cycling between the two years are unknown. However, many factors varied between years such as season, diet, genetics, and social environment, all of which had potential to affect timing of puberty. At the time of PGF injection the number of heifers cycling increased to 84% with 38 of 45 heifers pubertal, there was a similar (P=0.58) increase to 75% in YII with 30 of 40 heifers pubertal. At this time YI IS heifers and YII IS heifers had similar weights (341″ 28.3 kg and 348″ 31.8 kg; P=0.26) but YI IS heifers were younger than YII IS heifers (278″ 15.0 d and 291″ 10.5 d of age; P<0.01). The YI and YII IS heifers were 68% and 70% of mature weight (assuming mature weight is 500 kg based on herd dams) at time of PGF injection. Also at AI of IS heifers, YI TRS heifers were 317″ 2.8 d and were much lighter than YI IS heifers (293″ 31.7 kg, P<0.01). Similarly, YII TRS heifers were 316″ 8.0 d of age and were also lighter than YI IS heifers (281″ 99.6 kg, P<0.01 YII).

TABLE 6
Characteristics of Integrated and Traditional Replacement System heifers prior to
synchronization and at time of prostaglandin injection.

| | 1 mo prior to MGA | | | | At time of PGF injection | | | |
|---|---|---|---|---|---|---|---|---|
| | Age | Weight | WDA | Cycling | Age | Weight | WDA | Cycling |
| | (d) | (kg) | (kg/d) | (%) | (d) | (kg) | (kg/d) | (%) |
| YI IS | 216 ± 15.0^{a} | 314 ± 28.0^{c} | 1.2 ± 0.09^{b} | 20^{b} | 278 ± 15.0^{a} | 341 ± 28.3^{c} | 1.2 ± 0.09^{c} | 81^{a} |
| YI TRS | 252 ± 2.8^{c} | 332 ± 25.6^{d} | 1.0 ± 0.04^{a} | 8^{a} | 314 ± 2.8^{c} | 293 ± 31.7^{a} | 0.9 ± 0.10^{a} | NA |
| YII IS | 228 ± 10.5^{b} | 296 ± 23.8^{b} | 1.3 ± 0.24^{c} | 0^{a} | 291 ± 10.5^{b} | 348 ± 31.8^{c} | 1.2 ± 0.10^{c} | 76^{a} |
| YII TRS | 252 ± 8.0^{c} | 259 ± 43.5^{a} | 1.0 ± 0.17^{a} | 28^{b} | 316 ± 8.0^{c} | 314 ± 20.2^{b} | 1.0 ± 0.06^{b} | NA |

^{a,b,c,d}Means in a colunm with different superscripts differ (P < 0.05).

Induction of early puberty of the IS heifers is attributed to the high plane of nutrition of the IS heifers. This conclusion is supported by Roux et al. (78) who reported a high plane of nutrition induced earlier onset of puberty and an increased percent of heifers with regular estrous cycles. Schillo et al. (83) hypothesized that nutritional status affects timing of increasing LH pulses and may involve the LH pulse generating system in the hypothalamus through an unknown mechanism. Kinder et al (44) stated that changes in body mass or fatness somehow affect LH pulses. Pre-pubertal heifers fed limited amount of energy had prolonged estradiol suppression and release of LH pulses compared to those fed a high-energy diet. High-energy diets are thought to result in larger dominant follicles earlier in life. Although plane of nutrition is inversely related to age at puberty, pattern of gain has no effect on age at puberty (33) as long as heifers reach approximately 60-65% of mature body weight (51) prior to breeding. Likewise, the pattern of gain in the current study did not affect the onset of puberty. The addition of rumensin in the diet is also thought to have hastened the onset of puberty. Randel (27) summarized several studies and found diets that had high propionate production in the rumen led to puberty at lighter weights. Similarly, Moseley et al. (62) and Purvis and Whittier (72) found that diets containing ionophores decreased the age at onset of puberty, not related to ADG or BW.

Weight of heifers seemed to have more influence than age on puberty (Table 7). The IS heifers that reached puberty at less than 9-mo of age were similar in age (P=0.66) and weight (P=0.15). However, the IS heifers that reached puberty at greater than 9-mo of age were of similar weight (P=0.44) but different ages (P<0.01). The IS heifers in YI and YII that reached puberty prior to PGF injection were of similar weight (P=0.29) and age (P=0.66). This supports data that weight of heifers tend to have a greater impact on the timing of puberty than age (4,78,79).

TABLE 7
Characteristics of Integrated System heifers at onset of puberty¹.

| | YI | YII |
|---|---|---|
| Total Integrated System Heifers | 43 | 38 |
| Onset of Puberty | | |
| Number of first heats | 35 | 29 |
| Age (d) | 248 ± 31.4 | 313 ± 54.1 |
| Weight (kg) | 316 ± 42.9 | 329 ± 56.8 |
| Onset of Puberty <9 mo of age | | |
| Number of first heats | 23 | 6 |
| Age(d) | 233 ± 27.1 | 227 ± 31.3 |
| Weight (kg) | 296 ± 36.9 | 262 ± 82.4 |
| Onset of Puberty >9 mo of age | | |
| Number of first heats | 13 | 23 |
| Age (d) | 279 ± 6.0^{a} | 335 ± 30.9^{b} |
| Weight (kg) | 355 ± 21.4 | 347 ± 31.8 |

¹Onset of puberty determined by serum progesterone (>1 ng/ml).
^{a,b}Catagorical means in the same row with different superscripts differ (P < 0.01).

Heifers that became pregnat to sexed semen on the first service of AI was 23% and 8% of those cycling and fixed-time mated, YI and YII respectively (Table 8). Overall conception rate and pregnancy rates were 71% and 58% YI and 21% and 16% YII. The low conception rate may be due to any one or a combination of properties of semen used such as low numbers and motility of semen in each dose (3×10⁶ YI and 6×10⁶ YII, with at least 35% post-thaw motility). Seidel et al. (87) found low-dose sexed-semen to lower conception rate by 10-20% over normal-dose non-sexed semen. In YII pregnancy rate within each insemination was not affected by sexed semen sorted for X chromosome than non-sexed semen of the same dose (P=0.51) for either first-service or second service (P=0.56). Likewise, sires within YI and across YI and YII had no affect pregnancy as a result of first service (P=0.87 and P=0.45, YI and YII respectively). Technician also had no effect on pregnancy in YI (P=0.93) and YII (P=0.96).

TABLE 8
Reproduction rates of Integrated System heifers in Year I
and Year II.

| | YI | YII |
|---|---|---|
| Integrated System heifers | 43 | 38 |
| Number of Integrated System heifers cycling | 35 | 29 |
| Fixed-time Mating | | |
| Pregnant heifers | 8 | 3 |
| Pregnancy Rate of cycling heifers | 23% | 10% |
| Pregnancy Rate of all heifers | 19% | 8% |
| Post breeding season | | |
| Pregnant heifers | 25 | 6 |
| Pregnancy Rate of cycling heifers | 71% | 21% |
| Pregnancy Rate of all heifers | 58% | 16% |

Pregnancy rate in YI was not acceptable when one considers heifers were given 3 to 4 opportunities to become impregnated. Pregnancy rates in YII were very disappointing and there is no explanation for such poor performance. Perhaps the high morbidity of the heifers in YII interfered with reproductive function. Perhaps the combination of sexed-semen, low-dose insemination straws with very young breeding age of heifers may explain low pregnancy rates. Further investigation is needed to fully evaluate and draw conclusions about the mechanisms involved.

Pregnancy as a result of the first artificial insemination on a first or subsequent estrus did not have an affect on pregnancy (P=0.97). This result is in contrast to Byerley et al. (16) whom concluded that the first estrus was less fertile than the third estrus.

In YI fetal death occurred in 4 of the 25 IS heifers bred (16%). These IS heifers experienced early fetal loss and three were rebred by natural service as a result of IS heifers commingling with the normal herd during breeding season. These IS heifers were culled from the IS and sold as bred heifers at the local auction barn in Yuma, CO. Revenue ($650.00 per IS heifer) from these late-bred IS heifers was received by the IS and is included in the economic analysis. The forth IS heifer that experienced fetal loss did not rebreed and was kept in the IS, finished and harvested with her pregnant IS heifer counterparts.

Phase III: Parturition to Harvest

Parturition for IS heifers was difficult, 9 of the 22 (41%) IS heifers experienced dystocia and required assistance (Table 9), of which, three required assistance of greater effort. Fifty percent of all calves born had calving ease scores of 2 or greater. Dams that gave birth to male calves experienced greater calving difficulty than dams with female progeny (P<0.05); 56% of male calves and 44% of female calves were scored 2 or greater for calving difficulty. Dystocia problems probably stem from sire selection rather than due to heifer size or age. The two Black Angus bulls that semen was collected from in YI and packaged for AI did not differ in calving ease scores (P=1.0). The two bulls had BW EPDs of 0.5 and 1.5 with accuracies of 0.82 and 0.37 at time of selection for this study. However, in the following breeding season the EPDs for BW for the 2 sires increased to 2.3 and 4.1 with accuracies of 0.92 and 0.87 respectively. Birth weight did not statistically affect calving ease scores (P=0.41), but had a positive correlation to CE (P<0.05). It is believed that calf birth weights were the driving factor of dystocia as birth weight averaged 40″ 4.7 kg. High calving ease scores probably affects calf performance. This study showed no effect of CE on calf morbidity, ADG, or weaning weights. However, the small number of samples (20 calves) posses a problem for statistical analysis and a conclusion that CE has no effect on these factors would be misleading and inaccurate.

TABLE 9
Parturition and progeny of Year I Integrated System heifers.

| | Heifer Calves | Bull Calves | All Calves |
|---|---|---|---|
| Method of Mating Dam | | | |
| All Methods | 12 (60%) | 8 | 20 |
| Sexed Semen (AI) | 11 (69%) | 5 | 16 |
| Non-sexed Semen (AI) | 0 (0%) | 3 | 3 |
| Natural Service | 1 (100%) | 0 | 1 |
| Calf characteristics at Birth | | | |
| Birth weight (kg) | 36 ± 10.7^{a} | 40 ± 4.3^{a} | 39 ± 4.6 |
| Calving Ease¹ | 1.3 ± 0.49^{a} | 2.2 ± 0.75^{b} | 1.6 ± 0.70 |
| Calf Vigor² | 1.7 ± 1.13^{a} | 1.8 ± 1.17^{a} | 1.7 ± 1.13 |

¹1 = no assistance; 2 = assisted, easy; 3 = assisted, very difficult.
²1 = nursed immediately, calf health, strong; 2 = nursed on own, but took some time.
^{a}Means in a row with different superscripts differ (P < 0.05).

Twelve of the 20 (60%) calves born were female (Table 9). Eleven of the 16 (69%) calves conceived from semen sorted for X-chromosome were female and all three calves conceived from non-sexed semen were bulls (100%) whereas the only calf born to natural serve was female (100%). Seidel et al. (87) reported that 86% of calves conceived from sexed semen are of the desired sex. The result of this data set of 69% of calves conceived to sexed semen were of desired sex, is not an adequate replication of their study as too few individuals were used. The low percent of desired sex was not expected as the true percent of X-chromosome sperm varied from 86-92% for the batches of semen used in the study.

The IS calves experienced 35% mortality and an additional 15% experienced morbidity. Two of the seven deaths occurred as a result of dystocia, with death occurring at or shortly after birth. Two deaths were due to accidents and the remaining three calves perished as a result of diphtheria (diagnosed by the local veterinarian). Morbidity may have resulted from inadequate calving facilities. The IS heifers calved in a dry lot pen in the feedlot. Manure management of the pen was unsatisfactory and depth of manure caused udder cleanliness to be at sub-optimal. Calving management may be one of the greatest challenges of the IS. Calving out of synchrony with other herd-mates causes labor difficulties. Additionally, calving in November through December at an operation where other feedlot animals occupy pens generate further difficulties if space is limited as well and contribute to time-management problems among employees. Weather conditions for the most part, did not affect calf mortality or morbidity as calves perished due to infectious disease rather than climatic conditions.

The high incidence of dystocia is consistent with data reported by Boucque (11). He reported that 24 and 25-mo-old SCH Belgian White heifers bred to Charolais sires resulted in caesarean procedures on 30-37.5% and 15-25% stillbirth or death within 24 h postpartum. The high incidence of dystocia was probably due to high calf birth weight (43.8 kg and 43.9 kg). Roux et al. (78) reported similar calving difficulties in 10 mo old Friesian and Friesian X Charolais heifers bred to Aubrac and Angus sires; 39% assisted by a manager and 5% required veterinarian intervention. Incidence of calving difficulties has also reported by Bailey (5) using crossbred heifers; bred to Texas Longhorn sires less than 4% dystocia occurred, but when mated to Red Angus sires had 28% dystocia. Roux et al. (78) also found that heifers experiencing dystocia had significantly smaller pelvic measurements than heifers that calved unassisted. In the current study, no pelvic measurements were recorded in YI; however, pelvic measurements of YII IS heifers were not different to YII TRS heifers; it can be speculated that YI results would have been similar. Coleou et al. (17) reported very similar calving difficulties to the current study. In their study of Normand heifers calving at 19 mo of age, 31% required assistance, 14% experienced prenatal mortality of calves and there was 29% total mortality of calves before 3 months of age. Likewise, these calves had high birth weights of 38.5 kg.

Other researchers have also found that calf loss due to dystocia depends highly on level of supervision during calving (18). Simon et al (91) reported that under typical feedlot conditions, pregnant feedlot heifers displayed 29% calf death loss. They also reported that the high incidence of dystocia is due to a lack of facilities and unfavorable calving conditions. Nevertheless, a producer must use selection to optimize both calving ease and progeny value according to the management ability (13).

Integrated System heifer and calf performance was acceptable in the feedlot. Weaning weights of IS calves averaged 116″ 26.1 kg at 109″ 16.7 d of age and overall average daily gain of 1.0″ 0.08 kg. Average daily gains for the IS heifers varied from 1.6″ 1.03 kg during late gestation to early lactation and then decreased to 0.4″ 0.34 kg during late lactation to weaning and increased from weaning to harvest to 1.4″ 0.31 kg. Average daily gain over the 157 d PIII feeding period for IS heifers was 1.4″ 0.31 kg. The IS heifer performance was fairly constant over all heifers. This may be because a high level of cross suckling occurred, so even though difference in calf age was high, each dam probably milked the same amount. Heifers that lost their calves at birth or shortly there after, continued to lactate to help support calves of other dams. Other researchers have also noted a high incidence of cross suckling among SCH rearing calves under feedlot conditions (13,35). Total live-weight produced from the final twenty-two IS heifers and calves was 894″ 65.7 kg. No mortality or morbidity was experienced by the IS heifers during Phase III.

Brethour and Jaeger (13) reported that for each day delay in weaning, calf gain was 0.54 kg while gain of the dam was reduced by the equivalent amount. They therefore early weaned calves at 10-12 weeks (70-90 d) of age. The current data also found that as lactation increased to support greater calf gain, dam gain decreased. Once calves were removed, gain increased for the IS heifers. However, it must be noted that only five animals ever experienced weight loss at any point during PIll and weight loss never exceeded 0.6 kg/d with in a 28 d weigh period. This weight loss may not have been body tissue, rather, may be attributed to gut fill as animals were not fasted prior to weighing nor were weights measured two consecutive days to minimize gut fill affect on weights.

Reiling et al (74) managed postpartum SCH in a feedlot on 85% concentrate diet at 13.4% CP. He noted that calves weaned at 117 d of age weighed 159 kg. Their results show better feedlot performance than the current study, however, Reiling et al. (74) weaned calves at an older age. They also reported that at the time of weaning, SCH had sub-cutaneous fat at a depth of 1.1 cm whereas, in the current study, IS heifer BF was 0.27 cm as determined by ultrasonography. In the current study, postpartum SCH were managed on 96% concentrate diet at 11.8% CP. The difference in performance between the two studies cannot be explained entirely by diet. However, varying season, genetics, and lactation ability may explain some of the difference. Brethour and Jaeger (13) found performance of SCH to be uneven, the previous comparison demonstrates variability in the system in relation to time, genetics, and management.

Phase IV: Carcass Characteristics

The IS heifers were harvested at 715″ 15.0 d of age (24-mo) weighing 613″ 46.1 kg. Colorado State University personnel and a USDA Grader measured means and standard deviations of carcass characteristics (KPH, fat thickness, degree of marbling, ribeye area, lean maturity scores, and bone maturity scores) (Table 11). Eight of the 22 IS heifers received bone maturity score of “B.” However, all had lean maturity scores of “A” (Table 10), and only four of the 8 carcasses resulted in overall “B” maturity scores. These results support the theory proposed by other researchers, that pregnancy and lactation affect bone ossification to a greater extent than lean maturity scores (Table 12). Field et al. (76) reported the most exaggerated trend; 18 head of 33-mo-old SCH had lean maturity of “A” but bone maturity “C” According to USDA (103), carcasses with “C” skeletal or lean maturity will remain “C” maturity regardless of the other physiological score. Overall maturity remained “C” maturity. Waggoner et al. (105) reported average overall carcass maturity scores of the SCH were “B” (105″ 3.0), bone maturity score of “B” (116″ 3.6), and lean maturity score of “A” (80″ 3.2) with only 3 of 84 carcasses reported as AC@ maturity. Field et al. (26) reported that parity did not affect lean firmness. However, lean color tended to be darker as animal aged from yearling maiden heifers to 2-yr old maiden heifers. Pregnancy of 30-mo old SCH resulted in lighter lean color than 2-yr old maiden heifers. Some studies reported maiden females had greater maturity scores in lean color (5,74,104,105). Hermesmeyer et al. (35) reported that lactating SCH had greater lean maturity scores than did open heifers of the same age, but bone maturity scores did not differ. Therefore, overall maturity scores were greater for SCH than open heifers. In contrast, other research data found no difference between lean color of SCH and maiden heifers (10,14,26,78). In the current study, effect of pregnancy and lactation as separate factors on bone and lean maturity could not be accessed as the IS heifers that lost their calves continued to lactate as a result of cross-suckling.

TABLE 10
Carcass characteristics of individual Integrated System heifers n Year I.

| | | | | | | | | | | | Calculated | | USDA Grader | |
|---|---|---|---|---|---|---|---|---|---|---|---|---|---|---|
| Animal | Bone | Lean | Overall | Degree of | HCW | | Adjusted | Adjusted | REA | KPH | Quality | Yield | Quality | Yield |
| ID | Maturity^{a} | Maturity^{a} | Maturity^{a} | Marbling^{b} | (kg) | PYG | PYG | Fat (cm) | (cm²) | (%) | Grade | Grade | Grade | Grade |
| 152 | 70 | 60 | 65 | 390 | 724 | 3 3 | 3 3 | 0 52 | 13.3 | 1.5 | Ch | 2.60 | Ch | 3 |
| 155 | 90 | 100 | 95 | 610 | 756 | 2.5 | 2.6 | 0 24 | 11.4 | 1.5 | Ch | 2.62 | Ch | 2 |
| 108 | 80 | 80 | 80 | 570 | 762 | 3 | 3.1 | 0.44 | 13.1 | 2 | Ch | 2.70 | Ch | 2 |
| 110 | 80 | 100 | 90 | 410 | 746 | 3 | 3.2 | 0 48 | 13 | 2 | Ch | 2.77 | Ch | 2 |
| 167 | 130 | 60 | 95 | 460 | 888 | 3 3 | 3 3 | 0 52 | 14.9 | 2 | Ch | 2.61 | Ch | 3 |
| 165 | 60 | 80 | 70 | 360 | 791 | 3.5 | 3.3 | 0 52 | 13.5 | 2 | Ch | 2 89 | Ch | 2 |
| 179 | 110 | 70 | 90 | 460 | 929 | 3.5 | 3.5 | 0.6 | 15 4 | 2 | Ch | 3.00 | Ch | 3 |
| 192 | 70 | 70 | 70 | 420 | 777 | 3.5 | 3.6 | 0.64 | 14 | 2.5 | Ch | 3.07 | Ch | 3 |
| 134 | 60 | 70 | 65 | 480 | 821 | 3 2 | 3 3 | 0.52 | 13 3 | 2.5 | Ch | 3.16 | Ch | 3 |
| 151 | 70 | 70 | 70 | 500 | 820 | 3.3 | 3.3 | 0 52 | 12.9 | 25 | Ch | 3 29 | Ch | 3 |
| 186 | 120 | 50 | 85 | 520 | 828 | 3.3 | 3 4 | 0.56 | 13.1 | 2.5 | Ch | 3.35 | Ch | 3 |
| 131 | 180 | 90 | 135 | 410 | 848 | 3.8 | 3 9 | 0 76 | 14.8 | 2.5 | Ch | 3.39 | Ch | 3 |
| 127 | 80 | 110 | 95 | 430 | 848 | 3.3 | 3 4 | 0.56 | 11.5 | 1 5 | Ch | 3.74 | Ch | 3 |
| 180 | 60 | 80 | 70 | 520 | 733 | 3 7 | 3.7 | 0 68 | 11.6 | 2.5 | Ch | 3.77 | Ch | 3 |
| 195 | 70 | 70 | 70 | 440 | 766 | 4 | 4 | 0.8 | 12 | 2 | Ch | 3.97 | Ch | 3 |
| 137 | 170 | 60 | 115 | 450 | 911 | 4.3 | 4.3 | 0.92 | 13 7 | 2 | Ch | 4 28 | Ch | 3 |
| 177 | 140 | 60 | 100 | 500 | 836 | 4 8 | 4 8 | 1.12 | 14.5 | 2 5 | Ch | 4.34 | Ch | 4 |
| 138 | 80 | 70 | 75 | 340 | 751 | 2 7 | 2 7 | 0 28 | 15 3 | 1 | Se | 1 36 | Se | 2 |
| 213 | 70 | 90 | 80 | 380 | 698 | 2 7 | 2 8 | 0 32 | 12 5 | 1 | Se | 2 15 | Se | 2 |
| 163 | 60 | 70 | 65 | 350 | 760 | 2 8 | 3 | 0 4 | 12 2 | 2 | Se | 2 88 | Se | 2 |
| 143 | 180 | 80 | 130 | 380^{b} | 778 | 3 | 3 3 | 0 52 | 14 4 | 2 | St | 2 55 | Se | 2 |
| 205 | 160 | 60 | 110 | 430^{b} | 737 | 5 | 3 | 0 4 | 11 9 | 2 | St | 2 89 | Ch | 2 |

^{a}0-99 = A⁰-A⁹⁹, 100-199 = B⁰-B⁹⁹
^{b}300-399 = Slight⁰-Slight⁹⁹, 400-499 = Small⁰-Small⁹⁹; 500-599 = Modest⁰-Modest⁹⁹, 600-699 = Moderate⁰-Moderate⁹⁹

The IS heifers averaged Small degree of marbling (Table 11). Of the 17 carcasses that received overall maturity scores of “A”, 14 carcasses received Choice quality grades, and 3 carcasses received Select quality grades (Table 10). Of the 5 carcasses that received overall carcass maturity score “B”, 1 of the carcasses had enough marbling (Modest⁰) to remain in the Choice quality grade. The other 4 carcasses received Standard quality grade as a result of Small degree of marbling. These four carcasses received financial discounts of $11.87 per cwt (Table 5). Other discounts received included 9 of the 22 carcasses with YG of 3 at $1.00/cwt and 2 of the 22 carcasses with YG of 4 at $20.00/cwt. Consequently, one the carcasses that received YG 4 was also a “B” maturity carcasses. One of the 2 YG 4 had the minimum degree marbling to remain in Choice quality grade. However, since the discount for YG 4 is greater than for a Standard carcass, one should not keep animals on feed too long to attempt to increase intramuscular fat in order to overcome “B” maturity carcasses resulting in Standard grade. Furthermore the other carcasses that received YG 4 also received Standard quality grade and the discount for this particular carcass was $36.87/cwt.

TABLE 11
Carcass characteristics of Integrated System heifers in Year I according to carcass matunty score classification

| | | HCW | Dressing | Bone | Lean | Overall | | Adj Fat | REA | | Quality | Yield |
|---|---|---|---|---|---|---|---|---|---|---|---|---|
| | n | (kg) | (%) | Maturity^{a} | maturity^{a} | Maturity^{a} | Marbling^{b} | (cm) | (cm²) | KPH | Grade | Grade |
| “A” | 17 | 357 ± 27.5 | 60 ± 2.5 | 80 ± 21 2 | 76 ± | 78 ± | 449 ± | 1 28 ± | 84 64 ± | 1 94 ± | Small⁵⁰ | 2 95 ± |
| Maturity | | | | | | 1 3 | 77 1 | 0 361 | 7 991 | 0.496 | | 0 623 |
| “B” | 5 | 373 ± 30 2 | 61 ± 0 6 | 166 ± 8 8 | 70 ± 13 0 | 118 ± | 434 ± | 1 89 ± | 89 42 ± | 2 20 ± | Small³⁰ | 3 49 ± |
| Maturity | | | | | | 10 5 | 26 9 | 0 526 | 7 185 | 0 219 | | 0 657 |
| All | 22 | 361 ± 28 2 | 60 ± 2 2 | 100 ± 41 9 | 75 ± 15 4 | 87 ± | 446 ± | 1 42 ± | 85.72 ± | 2 00 ± | Small⁵⁰ | 3 07 ± |
| IS heifers | | | | | | 20 7 | 70 4 | 0.521 | 7 980 | 0.463 | | 0 687 |

^{a}0-99 = A⁰-A⁹⁹; 100-199 = B⁰-B⁹⁹
^{b}300-399 = Slight⁰-Slight⁹⁹, 400-499 = Small⁰-Small⁹⁹, 500-599 = Modest⁰-Modest⁹⁹, 600-699 = Moderate⁰-Moderate⁹⁹

The IS heifers deposited intramuscular adequately as most were of Choice quality grade. However, due to the influence of “B” maturity, 4 carcasses were graded Standard. The occurance of Standard carcasses are of major economical concern as these carcasses were discounted by $11.87/cwt under the base price and Choice carcasses were given premiums of only $0.97/cwt over the base price (Table 5). With this particular grid, it would take about 12 Choice carcasses to compensate for the discounts of a single Standard carcass of the same Yield Grade and weight. The USDA (103) made a change to the role of which B maturity plays in quality grades. Currently, B-maturity carcasses with less than modest degree of marbling will be graded standard; those carcasses with at least modest degree of marbling will receive the Choice grade or better. The new grading standard may increase the incidence of heiferetts graded Standard (75) from studies conducted on SCH studies in the past. Standard grade of a carcass is associated with discounts and may be a major economic impact on profitability of feeding SCH (26,74,100,105).

In the current study, only 1 of the 4 “B” maturity carcasses remained in Choice quality grade due to Modest degree of marbling, whereas before the grade standard change, all 4 carcasses would have been graded Choice. Likewise, many previous studies that reported a high incidence of Choice carcasses would now result in lower grade of Standard. Hermesmeyer et al. (36) reported that 74% of the SCH received USDA Choice, YG 3. Likewise, Reiling et al. (75) reported that approximately 50% of SCH would have received USDA Choice under the old USDA Grade Standards (102). However, under current USDA Standards (103) the percent of heiferetts that would receive the same grade would decrease to about 40%.

The results of this study are similar to the carcass characteristics found by many other SCH system studies (Table 12), even though animals were 24-mo of age compared to 30-mo old heifers. However, several studies have reported some carcass maturity scores of “C” (26,74,75,105). In the current study, no incidence of “C” maturity occurred. Similarly, Brethour and Jaegar (13) and Waggoner (105) found no carcasses with carcass maturity scores of “C”.

TABLE 12
Review of previous research: single-calf heifer carcass characteristics.

| | | Age | Bone | Lean | Overall | | Yield |
|---|---|---|---|---|---|---|---|
| | n | (mo) | Maturity^{a} | Maturity^{a} | Maturity^{a} | Marbling^{b} | Grade |
| Field et al. (1997) Early Weaned Calves (120 d) | 18 | 33.2 | 202 | 59 | 200 | 390 | 3.30 |
| Waggoner et al. (1990) Early Weaned Calves (115 d) | 52 | 30 | 116 | 80 | 105 | 500 | 2.00 |
| Hermesmeyer (1999a) | | | | | | | |
| Exp 1. Lactating | 6 | 28 | 119 | 111 | 115 | 449 | 3.05 |
| Exp 2. Early Weaned Calves (64 d, 89 d) | 12 | 30 | 117 | 104 | 113 | 423 | 2.45 |
| Exp 2. Lactating | 10 | 30 | 145 | 141 | 143 | 407 | 2.89 |
| Reiling et al. (1995) Early Weaned Calves (117 d) | 29 | 27 | 98 | 68 | 82 | 475 | 3.08 |
| Reiling et al. (1996) | | | | | | | |
| Exp 2. Early Weaned Calves (111 d) | 23 | 32 | 139 | 120 | 138 | 415 | 2.27 |
| Exp 2. Early Weaned Calves (111 d) | 23 | 32 | 125 | 114 | 125 | 426 | 2.27 |
| Exp 3. Normal Weaned Calves (211 d) | 25 | 32 | 97 | 91 | 98 | 472 | 2.47 |
| Exp 3. Normal Weaned Calves (211 d) | 26 | 32 | 112 | 103 | 110 | 450 | 2.61 |

^{a}0-99 = A⁰-A⁹⁹; 100-199 = B⁰-B⁹⁹; 200-299 = C⁰-C⁹⁹
^{b}300-399 = Slight⁰-Slight⁹⁹; 400-499 = Small⁰-Small⁹⁹; 500-599 = Modest⁰-Modest⁹⁹; 600-699 = Moderate⁰-Moderate⁹⁹

Warner-Bratzler Shear Force and Sensory Taste Panel

Waggoner et al. (105), Joseph and Crowley (42), and Bond et al. (10) reported that juiciness and flavor was not affected by parity nor was sensory panel tenderness. Waggoner et al. (105) reported that sensory panelists found detectable connective tissue, myofibrillar and overall tenderness to be higher for yearling maiden heifers than either SCH or 2 yr-old maiden heifers. The WBS values were higher for SCH than maiden heifers. Therefore, calving had a negative affect on tenderness. Age increased sensory panel detectable connective tissue and the combined affect of age and parturition decreased tenderness over yearling maiden heifers. However, tenderness and palatability traits did not differ between 2 yr-old maiden heifers and SCH. Therefore, the SCH system resulted in meat palatability comparable to maiden heifers of a similar age as determined by sensory panelists. Vincent et al. (104) reported SCH did not differ in sensory panel ratings except for the oldest (33 mo of age) SCH, which had greater connective tissue. Joseph and Crowley (42) finished Hereford crossbred maiden heifers and SCH on pasture and reported that calved heifers appeared to be as acceptable to sensory panelists as maiden heifers and both were nearly as acceptable as steers. There was no significant difference in tenderness, juiciness or flavor between maiden heifers and SCH heifers. In the current study, 8 panelist rated the meat from the IS heifers quite acceptable. On an 8-point scale, panelists rated the steaks moderately juicy (6″ 0.99), moderate in muscle fiber tenderness (6″ 1.1), trace amount of connective tissue present (6″ 1.1), moderate in overall tenderness (6″ 0.95) and a flavor that is slightly detectable (1″ 0.61).

Classification of carcasses maturity as “A” or “B” did not affect any of the taste-panel characteristics evaluated (P>0.3). Although increasing carcass maturity is associated with a decrease in tenderness, juiciness and an increase in flavor intensity and off flavors, Hilton et al. (37) similarly found position within a maturity group had a negligible effect on palatability. Likewise, other researchers have reported sensory taste panel traits were undifferentiated between “A” and “B” maturity carcasses (99). In contrast to these studies and the current study, Smith et al. (93,94) reported steaks from “A” and “B” maturity carcasses, within equal marbling scores, were significantly different. The correlation between “A” and “B” maturity classifications are not clear and further research studies have provided evidence that has contributed to the confusion of the discrepancy between “A” and “B” maturity classifications and palatability. However, the combined effects of marbling and maturity, accounts for 30-40% of the observed variation in tenderness, 26% of the variation in juiciness, and 15% of variation in flavor (37).

All 22 steaks from the IS heifers were tender. The average Warner-Bratzler Shear force (WBS) value was 2.9″ 0.9. No incidence of tough steaks occurred in the current study as no steak exceeded WBS value of 4.5 (89). It is therefore concluded that steaks for 24-mo old SCH managed in the IS provide consumers with a highly palatable product.

Phase V: Economic Analysis

Economic analysis of each phase was conducted to determine net revenue/loss. Phase I (Table 13) of YI had a net loss of $28,800.49, due mainly to investment of IS heifers ($15,540.64) and 3 cows for androgenization ($1,470.00). Breeding was the second most costly expenditure at $3,210.74 followed by feed costs ($8,697.39). Revenue ($2,591.48) in Phase I was generated by cull androgenized cows and IS heifers due to poor feedlot performance (realizers).

TABLE 13
Income Statement for Year I Phase I.

| REVENUES | # Head | Ave WT | Market Price | Total |
|---|---|---|---|---|
| Cull Androgenized | 3 | 16.44 | $44.00 | $2,170.08 |
| Cow | | | | |
| Realizers | 2 | 4.9 | $43.00 | $421.40 |
| TOTAL | | | | $2,591.48 |
| GROSS INCOME | | | | $2,591.48 |
| EXPENSES | | | | |
| Livestock | # Head | Ave WT | Market Price | Total |
| IS Heifers | 46 | 3.28 | $103.00 | $15,540.64 |
| Androgenized Cow | 3 | 14 | $35.00 | $1,470.00 |
| Death Loss | 1 | 3.28 | $103.00 | $337.84 |
| of IS Heifer | | | | |
| TOTAL | | | | $17,348.48 |
| Feed | # Head | Intake (ton) | Price/ton | Total |
| Corn | 46 | 56.375 | $70.00 | $3,946.25 |
| Alfalfa Hay | | 17.882 | $55.00 | $983.51 |
| Medicated Feed | | 0.088 | $265.13 | $23.33 |
| Supplement 517 | | 13.372 | $185.00 | $2,473.82 |
| Markup | | 84.6987 | $15.00 | $1,270.48 |
| TOTAL | | 172.4157 | $590.13 | $8,697.39 |
| Yardage | # Head | Rate | # Head Days | Total |
| Head In | 43 | $0.20 | 9988 | $1,997.60 |
| Dead | 1 | $0.20 | 35 | $7.0 |
| Realized | 2 | $0.20 | 340 | $68.00 |
| TOTAL | 46 | | 10363 | $2,072.60 |
| Health | # Head | Rate | | Total |
| Processing | 48 | $1.00 | | $48.00 |
| Hospital drugs | | $10.76 | | $10.76 |
| Chute Charge | 4 | $1.00 | | $4.0 |
| TOTAL | | | | $62.76 |
| Breeding Cost | # Head | Rate | | Total |
| MGA | 43 | $3.08 | | $132.44 |
| PGF | 43 | $2.10 | | $90.30 |
| Semen Sorting Fee | 83 | $20.00 | | $1,660.00 |
| Semen Dose | 83 | $12.00 | | $996.00 |
| Technician Fee | 83 | $4.00 | | $332.00 |
| TOTAL | | | | $3,210.74 |
| TOTAL | | | | $31,391.97 |
| OPERATING | | | | |
| EXPENSE | | | | |
| NET REVENUE/ | | | | ($28,800.49) |
| LOSS | | | | |
| (Income-expenses) | | | | |

Phase II (Table 14) revenue was generated by sale of 18 IS heifers that had failed to get pregnant. These heifers were sold immediately after the final pregnancy check for $11,880.00. The expenses totaled $1,860.69. Pasture lease was $13.00 per AUM and each IS heifer was considered 0.65 AUM. The 18 open IS heifers remained in pasture with their pregnant counterparts for about 1 2 mo. The 25 pregnant IS heifers remained in pasture for about 6 2 mo. Net revenue for PII was $10,019.31. Phase III (Table 15) had a net revenue of $18,866.02. Major expenses included death loss of calves from the IS heifers ($2,415.60) and feed costs of $6,206.31. The major source of revenue was created by 22 IS heifers that were fed to finish and harvested. These heifers were marketed according to carcass merit (Table 5). Revenue created ($21,510.53) by the IS heifers are categorized according to carcass merit in Table 16.

The IS was not more profitable than traditional management system of non-replacement heifers in which heifer calves are weaned at a traditional age of 200 d and sold immediately after weaning (Table 17). The gross revenue of the TMS was $21,834.80 generated by sale of 43 TW calves at $88.00/lb. Expense of the TMS was cow cost. Cow cost was calculated by taking the latest 5-year cow costs at ECRC and averaging ($19,352.58) then multiplying by 43 TMS calves. The difference between the IS and the TMS was $3,944.67 in favor of the TMS. However, in the simulations (Table 18) at 58% pregnancy rate, calf survival increased the difference to $3,679.36 in favor of the IS. This result demonstrates the economic importance of calf survival. By decreasing the number of calves that died from 27% to 2%, revenue increased by $7,624.03. It is therefore evident that calving management must take a priority in the final phase of the system. As stated previously, this period of time and level of supervision required may cause labor management problems. Hence, individual producers should evaluate adoption of this system according to management abilities.

The simulations (Table 18) showed that under the assumptions, the IS can be profitable above the TMS. The most appropriate figures to assess the system are those associated with 80% reproduction rate. This rate is the most acceptable pregnancy rate and could probably be achieve with the IS with further development and research into the project. At this pregnancy rate revenue above the TMS would be $7,321.37. However, achieving this pregnancy rate may or may not be accomplished. The simulations did not include wages for labor during the calving season nor did it include interest rates or opportunity costs. The simulations reported in this study should therefore be interpreted with caution, as profitability would certainly fall if these factors were included.

Implications

The integrated system in which early-weaning and sexed-semen are incorporated into the single-calf heifer system, is an accelerated system that allows one calf to be born to a heifer targeted for slaughter at 24-mo of age. The IS depends on achieving an early puberty allowing a IS heifer to be bred at 10-mo of age. A strong limiting factor of the system is the ability or the inability of a heifer at that age to become pregnant. Consumer satisfaction will not be jeopardized by meat provided by IS heifers as the end product is highly palatable to a taste-panel and very tender according to Warner-Bratzler Shear force. If a high reproduction rate can be achieved and calf mortality kept to a minimum, great profitability can be achieved over selling non-replacement heifers immediately following weaning at a traditional age. Although the IS has potential to be profitable and provide quality end product to the consumer, adoption of the system by an operation should be assessed on an individual basis according to managerial ability.

The discussion included in this United States patent application is intended to serve as a basic description of the invention. The reader should be aware that the specific discussion may not explicitly describe all the embodiments of the invention that are possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in functionally-oriented terminology, each aspect of the function can be accomplished by a device, subroutine, or program. Apparatus claims may not only be included for the devices described, but also method or process claims may be included to address the functions the inventions and each element performs. Neither the description nor the terminology is intended to limit the scope of the claims.

Further, each of the various elements of the invention and claims may also be achieved in a variety of manners. This disclosure should be understood to encompass each such variation, be it a variation of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered encompassed in the description of each element or action. Such terms can be substituted where desired to make explicit the implicitly broad coverage to which this invention is entitled. As but one example, it should be understood that all actions may be expressed as a means for taking that action or as an element that causes that action. Similarly, each physical element disclosed should be understood to encompass a disclosure of the action that physical element facilitates. Regarding this last aspect, as but one example, the disclosure of an “estrous synchronization element” should be understood to encompass disclosure of the act of “synchronizing estrous” —whether explicitly discussed or not—and, conversely, were there only disclosure of the act of “synchronizing estrous”, such a disclosure should be understood to encompass disclosure of a “estrous synchronization element” and even a means for “synchronizing estrous”. Such changes and alternative terms are to be understood to be explicitly included in the description.

Additionally, various combinations and permutations of all elements of applications can be created and presented. All can be done to optimize the design or performance in specific applications.

Any acts of law, statutes, regulations, or rules mentioned in this application for patent; or patent, publications, or other references mentioned in this application for patent are hereby incorporated by reference herein. Specifically, U.S. Provisional Patent Application Nos. 60/211093, filed on Jun. 12, 2000 and 60/224,050, filed on Aug. 9, 2000, and U.S. patent application Ser. No. 09/001,394, filed on Dec. 31, 1997 and U.S. patent application Ser. No. 09/015,454, filed Jan. 29, 1998 and PCT/US99/17165, filed Jul. 28, 1999, and “Cost Effectiveness of Utilizing Sexed-Semen in a Commercial Beef Cow Operation,” thesis of Nanette Lynn Steel, Department of Agriculture and Resource Economics, Summer of 1998 are each hereby incorporated by reference.

In addition, as to each term used it should be understood that unless its utilization in this application is inconsistent with such interpretation, common dictionary definitions should be understood as incorporated by reference for each term and all definitions, alternative terms, and synonyms such as contained in the Random House Webster's Unabridged Dictionary, second edition are hereby incorporated by reference. However, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim at least: I) the integrated herd management system described herein, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the application enhanced by the various systems or components disclosed, vii) the resulting products produced by such systems or components, ix) methods and apparatuses substantially as described hereinbefore and with reference to any of the accompanying examples, and x) the various combinations and permutations of each of the elements disclosed.

In addition, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible in countries such as Australia and the like.

I claim:

1. A method of managing animals, comprising the steps of:
a. producing a female of a species of mammal;
b. inseminating said female of said species of mammal with an artificial insemination sample having a plurality of spermatozoa, wherein at least 90% of said plurality of spermatozoa have a sex determination characteristic corresponding to the same sex of offspring mammal;
c. fertilizing at least one egg within said female of said species of mammal; and
d. producing said offspring mammal.

2. The method of managing animals as described in claim 1, wherein said sex determination characteristic comprises an X-chromosome.

3. The method of managing animals as described in claim 1, wherein said sex determination characteristic comprises an Y-chromosome.

4. The method of managing animals as described in claim 1, wherein said female of said species of mammal is selected from the group consisting of bovids, ovids, equids, canids, felids, and porcine.

5. The method of managing animals as described in claim 1, wherein said female of said species of mammal comprises a bovine species of mammal.

6. The method of managing animals as described in claim 5, wherein said plurality of spermatozoa comprises a number of spermatozoa selected from the group consisting of no more than 10 million live non-frozen spermatozoa, no more than 5 million live non-frozen spermatozoa, no more than 3 million live non-frozen spermatozoa, no more than 1 million live non-frozen spermatozoa, no more than 500,000 live non-frozen spermatozoa, no more than 250,000 live non-frozen spermatozoa, and no more than 100,000 live non-frozen spermatozoa.

7. The method of managing animals as described in claim 5, wherein said plurality of spermatozoa comprises a number of spermatozoa selected from the group consisting of no more than 10 million frozen-thawed spermatozoa, no more than 6 million frozen-thawed spermatozoa, no more than 5 million frozen-thawed spermatozoa, no more than 3 million frozen-thawed spermatozoa, no more than 1 million frozen-thawed spermatozoa, no more than 500,000 frozen-thawed spermatozoa, no more than 250,000 frozen-thawed spermatozoa, and no more than 100,000 frozen-thawed spermatozoa.

8. The method of managing animals as described in claim 1, wherein said female of said species of mammal comprises an equine species of mammal.

9. The method of managing animals as described in claim 6, wherein said plurality of spermatozoa comprises a number of spermatozoa selected from the group consisting of no more than 25 million live non-frozen spermatozoa, no more than 15 million live non-frozen spermatozoa, no more than 10 million live non-frozen spermatozoa, and no more than 5 million live non-frozen spermatozoa.

10. The method of managing animals as described in claim 6, wherein said plurality of spermatozoa comprises a number of spermatozoa selected from the group consisting of no more than 25 million frozen-thawed spermatozoa, no more than 15 million frozen-thawed spermatozoa, no more than 10 million frozen-thawed spermatozoa, and no more than 5 million frozen-thawed spermatozoa.

11. The method of managing animals as described in claim 1, wherein said plurality of spermatozoa comprises a number of spermatozoa from about 10% to about 50% relative to a typical number of spermatozoa in an artificial insemination sample.

12. The method of managing animals as described in claim 1, wherein said offspring mammal comprises a male, and wherein the percentage of male offspring mammals is selected from the group consisting of at least 70% male offspring mammals, at least 80% male offspring mammals, and at least 90% male offspring mammals.

13. The method of managing animals as described in claim 1, wherein said offspring mammal comprises a female, and wherein the percentage of female offspring mammals is selected from the group consisting of at least 70% female offspring mammals, at least 80% female offspring mammals, and at least 90% female offspring mammals.

14. The method of managing animals as described in claim 1, further comprising the step of inducing early puberty in said female of said species of mammal.

15. The method of managing animals as described in claim 14, wherein said female of said species of mammal comprises a female of a bovine species of mammal, and wherein said step of inducing early puberty in said female of said bovine species of mammal comprises inducing puberty by nine months after birth.

16. The method of managing animals as described in claim 14, wherein said step of inducing early puberty in said female of said bovine species of mammal comprises inducing said early puberty between about 250 days after birth to about 270 days after birth.

17. The method of managing animals as described in claim 14, wherein said step of inducing early puberty in said female of said bovine species of mammal comprises feeding said female of said bovine species of mammal a sufficient ration of feed to produce an average weight gain of about 1.3 kilograms per day to about 1.4 kilograms per day.

18. The method of managing animals as described in claim 14, further comprising the step of early weaning of said female of said species of mammal.

19. The method of managing animals as described in claim 18, wherein said female of said species of mammal comprises said female of said bovine species of mammal, and wherein said step of early weaning comprises weaning said female of said bovine species of mammal at between about 95 days to about 125 days after birth.

20. The method of managing animals as described in claim 18, wherein said step of inseminating said female of said bovine species of mammal comprises insemination of said female of said bovine species of mammal between about 283 days after birth to about 316 days after birth.

21. The method of managing animals as described in claim 18, further comprising the step of synchronizing estrous.

22. The method of managing animals as described in claim 21, wherein said step of synchronizing estrous comprises:
a. dressing feed with MGA at 0.5 milligrams per female of said bovine species of mammal per day for 14 days; and
b. injecting PGF2 19 days after the last day of dressing said feed with said MGA.

23. The method of managing animals as described in claim 22, further comprising the step of harvesting said female of said species of mammal.

24. The method of managing animals as described in claim 23, wherein said step of harvesting said female of said species of mammal comprises harvesting said female of said bovine species of mammal prior to 24 months.

25. The method of managing animals as described in claim 23, wherein said step of harvesting said female of said species of mammal comprises harvesting said female of said bovine species of mammal prior to 30 months.

26. The method of managing animals as described in claim 23, further comprising the step of replacing said female of said species of mammal with said offspring mammal.

27. The method of managing animals as described in claim 3, further comprising the step of harvesting said male offspring mammal.
